(19) United States
(12) Patent Application Publication
(10) Pub. No.: US 2024/0382921 A1
(43) Pub. Date: Nov. 21, 2024

(54) REACTOR CONFIGURATION, SYSTEM AND METHOD FOR PRODUCING CARBON MATERIAL AND SYNGAS

(71) Applicant: Qatar Foundation for Education, Science and Community Development, Doha (QA)

(72) Inventors: Nimir O. ELBASHIR, Doha (QA); Mohamedsufiyan Azizurrehman CHALLIWALA, Doha (QA); Hanif Ahmed CHOUDHURY, Doha (QA)

(21) Appl. No.: 18/436,165

(22) Filed: Feb. 8, 2024

Related U.S. Application Data
(60) Provisional application No. 63/444,134, filed on Feb. 8, 2023.

(51) Int. Cl. B01J 8/18; C01B 3/44; C01B 32/16

(52) U.S. Cl. CPC B01J 8/1827; B01J 8/1836; B01J 8/1872; C01B 3/44; C01B 32/16; B01J 2208/00884; C01B 2203/0238; C01B 2203/1058; C01B 2203/1082; C01B 2203/1241

(57) ABSTRACT

A reactor configuration, system and method for producing a carbon material and a syngas, such as, for CARGEN® technology, are provided. The reactor configuration, system and method includes/utilizes a reactor including a fluidized bed reactor having one or more vertical reactor tubes, or the reactor system includes a chemical vapor deposition reactor including one or more horizontal reactor tubes.

### CROSS REFERENCE TO RELATED APPLICATIONS

This application claims the benefit of U.S. Provisional Application No. 63/444,134 filed Feb. 8, 2023, which is incorporated herein by reference in its entirety.

### BACKGROUND

The reforming of methane is one of the most common industrial processes for conversion of organic compounds (e.g., natural gas, which is composed primarily of methane) to synthesis gas (or “syngas”) using an oxidant. Syngas, which is primarily a mixture of hydrogen and carbon monoxide, is an important feedstock for the production of a variety of value-added chemicals, particularly hydrocarbon cuts, such as liquid transportation fuels via Fischer-Tropsch synthesis, methanol and dimethyl ether, for example. The oxidant used for reforming of the methane determines its type. For example, in the case of steam reforming, steam is used as the oxidant. In partial oxidation, oxygen is used as an oxidant to produce syngas. In dry reforming, carbon dioxide is utilized for oxidation purposes

Much research in methane reforming has been directed towards improvement in the reactant conversions, either through new catalyst materials or by optimization of the operating conditions for a set objective. For example, attention has been directed towards dry reforming of methane due to its ability to convert the two greenhouse gases (i.e., methane and carbon dioxide) to syngas. However, the commercial applicability of dry reforming of methane has been very limited due to its inherent process limitations, such as carbon deposition, high endothermicity of the reaction, and low values of synthesis gas yield ratios (H₂:CO ratio).

The implementation of such dry reforming has typically suffered from carbon formation in the dry reforming reaction. The carbon formed on the surface of the catalyst deactivates the catalyst due to formation of the carbonate phase, thus either requiring frequent regeneration or, in certain cases, permanently destroying the active site. It would be desirable to design a reactor for implementing the reforming of methane with enhanced carbon dioxide fixation. Thus, a reactor, system and process solving, for example, the aforementioned problems is desired.

### SUMMARY

The present application generally relates to a reactor configuration, system and method for producing a carbon material and a syngas, such as, for CARGEN® technology.

In a first aspect of the present disclosure, which may be combined with any other aspect listed herein unless specified otherwise, a reactor system for producing a carbon material and a syngas, including: a reactor configured for receiving a gas feed including a greenhouse gas and producing a carbon material and a reactor gas feed. The reactor includes a fluidized bed reactor including a vertical reactor tube configured for conducting fluidization of a catalyst using the gas feed to form the carbon material and the reactor gas feed, and the reactor gas feed is utilized to produce the syngas.

In a second aspect of the present disclosure, which may be combined with any other aspect listed herein unless specified otherwise, the reactor includes a plurality of heating zones.

In a third aspect of the present disclosure, which may be combined with any other aspect listed herein unless specified otherwise, the heating zones of the reactor are capable of heating up to 1000° C.

In a fourth aspect of the present disclosure, which may be combined with any other aspect listed herein unless specified otherwise, the reactor includes a catalyst bed provided on one or more perforated plates that allow for a suitable flow of the gas feed.

In a fifth aspect of the present disclosure, which may be combined with any other aspect listed herein unless specified otherwise, the catalyst includes a CARGEN® catalyst.

In a sixth aspect of the present disclosure, which may be combined with any other aspect listed herein unless specified otherwise, the greenhouse gas includes one or more of a volatile organic compound, a hydrocarbon, carbon dioxide gas, oxygen gas, air, nitrogen, carbon monoxide, and hydrogen.

In a seventh aspect of the present disclosure, which may be combined with any other aspect listed herein unless specified otherwise, the vertical reactor tube is composed of steel, a metal alloy, or a protective internal coated metal tube.

In an eight aspect of the present disclosure, which may be combined with any other aspect listed herein unless specified otherwise, the carbon material includes carbon nanotubes.

In a ninth aspect of the present disclosure, which may be combined with any other aspect listed herein unless specified otherwise, the reactor is scalable for production of up to tons the carbon material.

In a tenth aspect of the present disclosure, which may be combined with any other aspect listed herein unless specified otherwise, further including a second reactor configured to receive a second reactor feed gas including the reactor feed gas and to produce the syngas.

In an eleventh aspect of the present disclosure, which may be combined with any other aspect listed herein unless specified otherwise, a reactor system for producing a carbon material and a syngas, including: a reactor configured for receiving a gas feed including a greenhouse gas and producing the carbon material and a reactor gas feed. The reactor includes a chemical vapor deposition reactor including a horizontal reactor tube configured to facilitate reaction of a catalyst due to flow of the gas feed through the reactor to form the carbon material and the reactor gas feed, and the reactor gas feed is utilized to produce the syngas.

In a twelfth aspect of the present disclosure, which may be combined with any other aspect listed herein unless specified otherwise, the horizontal reactor tube is composed of quartz, steel, a metal alloy, or a protective internal coated metal tube.

In a thirteenth aspect of the present disclosure, which may be combined with any other aspect listed herein unless specified otherwise, the greenhouse gas includes one or more of a volatile organic compound, a hydrocarbon, carbon dioxide gas, oxygen gas, air, nitrogen, carbon monoxide, and hydrogen.

In a fourteenth aspect of the present disclosure, which may be combined with any other aspect listed herein unless specified otherwise, the catalyst includes a CARGEN® catalyst.

In a fifteenth aspect of the present disclosure, which may be combined with any other aspect listed herein unless specified otherwise, the reactor is scalable for production up to tons the carbon material.

In a sixteenth aspect of the present disclosure, which may be combined with any other aspect listed herein unless specified otherwise, the carbon material includes carbon nanotubes.

In a seventeenth aspect of the present disclosure, which may be combined with any other aspect listed herein unless specified otherwise, further including a second reactor configured to receive a second reactor feed gas including the reactor feed gas and to produce the syngas.

In an eighteenth aspect of the present disclosure, which may be combined with any other aspect listed herein unless specified otherwise, a method for producing a carbon material and a syngas, the method including utilizing a reactor configured for receiving a gas feed including a greenhouse gas and producing a carbon material and a reactor gas feed. The reactor includes a fluidized bed reactor including a vertical reactor tube configured for conducting fluidization of a catalyst using the gas feed to form the carbon material and the reactor gas feed, and the reactor gas feed is utilized to produce the syngas.

In a nineteenth aspect of the present disclosure, which may be combined with any other aspect listed herein unless specified otherwise, a method for producing a carbon material and a syngas, the method including utilizing a reactor configured for receiving a gas feed including a greenhouse gas and producing the carbon material and a reactor gas feed. The reactor includes a chemical vapor deposition reactor including a horizontal reactor tube configured to facilitate reaction of a catalyst due to flow of the gas feed through the reactor to form the carbon material and the reactor gas feed, and the reactor gas feed is utilized to produce the syngas.

The reactor of the present disclosure is highly scalable for use, such as, with CARGEN® technology, to produce bulk quantities of carbon material, such as, up to tons of carbon material production (e.g., carbon nanotubes), and which carbon material is of high economic value and demand.

Additional features and advantages are described herein, and will be apparent from the following Detailed Description.

### BRIEF DESCRIPTION OF THE FIGURES

FIG. 1 shows the design of the fluidized bed reactor, according to an embodiment of the present subject matter.

FIG. 2 shows a single tube illustration of the CARGEN® CVD reactor illustration, according to an embodiment of the present subject matter.

FIG. 3 shows a schematic illustration of CARGEN® CVD reactor, according to an embodiment of the present subject matter.

FIG. 4 shows characterization images of MWCNTs showcasing (a) SEM images of the MWCNTs and (b) STEM images of the MWCNTs showing the inner and outer diameters of a single MWCNT, according to an embodiment of the present subject matter.

FIG. 5 shows a quantitative assessment of the carbon quality in terms of amorphous carbon and MWCNT carbon using (a) TGA results and (b) DTA results, according to an embodiment of the present subject matter.

FIG. 6 shows Raman plots of the commercial, multi-gram CARGEN®, and multi-kilogram scale CARGEN® samples, according to an embodiment of the present subject matter.

FIG. 7 shows a PFD of the CARGEN® Reactor in CVD mode, according to an embodiment of the present subject matter.

FIG. 8 shows a P&ID of the CVD based CARGEN® Technology with two reactor configurations with recycle, according to an embodiment of the present subject matter.

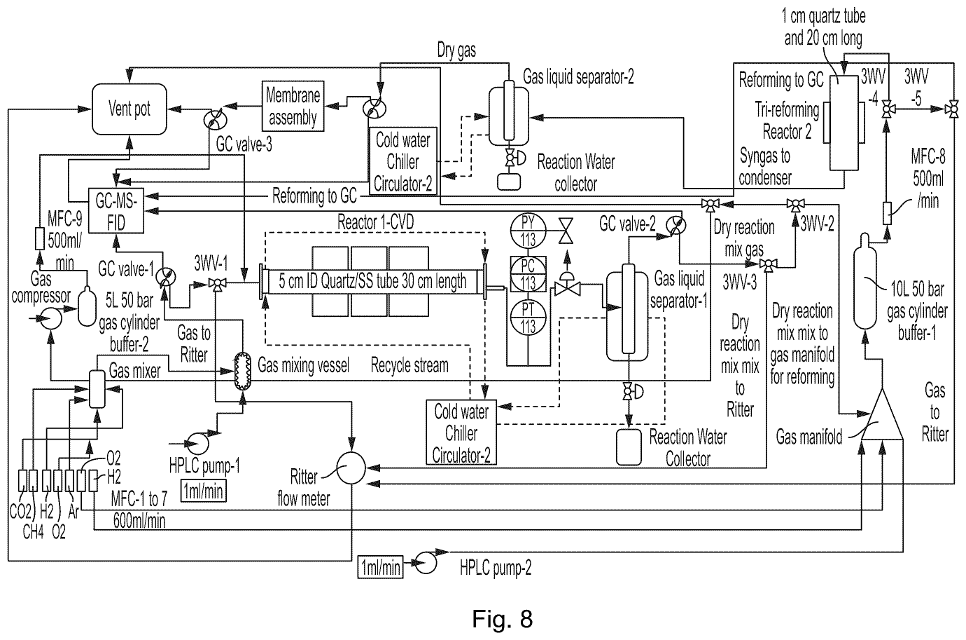

FIG. 9 shows a P&ID of the Fluidized bed CARGEN® Technology with two reactor configurations with recycle, according to an embodiment of the present subject matter.

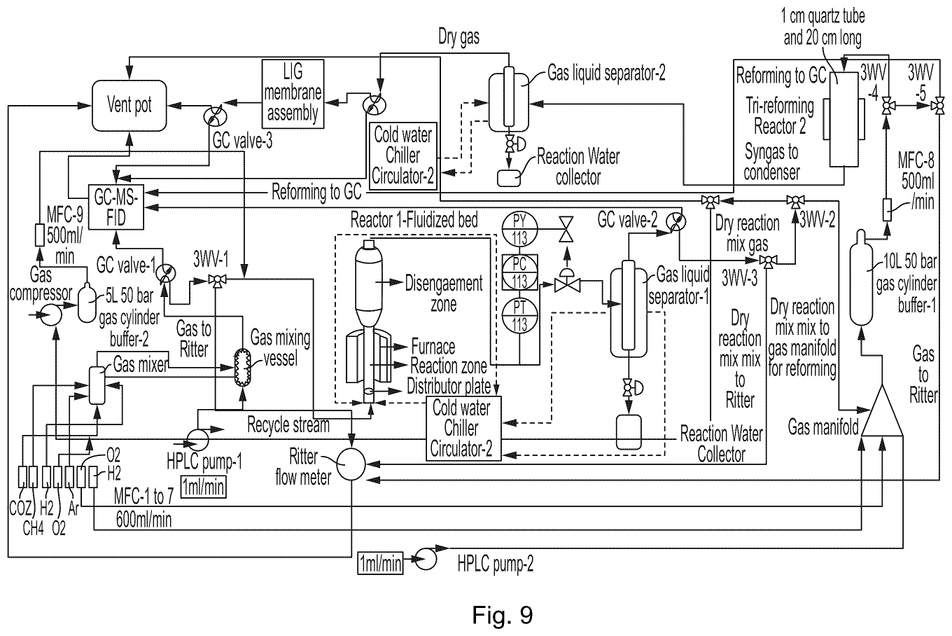

FIG. 10 shows an Aspen simulation for sizing of the reactor flange, according to an embodiment of the present subject matter.

FIG. 11 shows the actual flammability envelope defining flammable mixtures of methane, according to an embodiment of the present subject matter.

FIG. 12 shows a fire ternary plot for gas composition for desired operation, according to an embodiment of the present subject matter.

FIG. 13 shows a fire ternary plot for gas composition for fully open tube of the MFC, according to an embodiment of the present subject matter.

FIG. 14 shows a fire ternary plot for gas composition for a leak in the reactor tube, according to an embodiment of the present subject matter.

FIG. 15 shows a fire ternary plot for gas composition of Hydrogen, air, and steam, according to an embodiment of the present subject matter.

FIG. 16 shows a fire ternary plot for gas composition of Hydrogen, air and steam in a situation when oxygen MFC loses control and remains wide open to flow about 37986 mL/min gas, according to an embodiment of the present subject matter.

FIG. 17 shows a fire ternary plot for gas composition of Hydrogen, air, and steam in a situation when there is a leak in the reaction chamber/reactor tube, according to an embodiment of the present subject matter.

FIG. 18 shows a process flow diagram to depict operation of a carbon generation reactor, according to an embodiment of the present subject matter.

FIG. 19 shows a process flow diagram to depict operation of a two-reactor setup for enhanced CO₂ fixation, according to an embodiment of the present subject matter.

### DETAILED DESCRIPTION

CARGEN® technology presents a novel pathway for converting greenhouse gases (GHGs, comprising of volatile organic compounds, hydrocarbons, CO₂ gas, oxygen gas, air, nitrogen, carbon monoxide, hydrogen, etc.) to solid carbon and syngas via an integrated two-reactor configuration, such as provided in US20200109050A1, AU2018249486B2, and WO2018187213A1, the entire contents of which are incorporated herein by reference. The present disclosure, in an embodiment, provides specific reactor configurations for the first reaction relating to the CARGEN® technology, i.e., the production of carbon material by the reaction of GHGs. The present disclosure, in an embodiment, relates to the use of the fluidized bed reactor or the chemical vapor deposition (CVD) reactor for the CARGEN® reaction. In particular, the fluidized bed reactor configuration includes a vertical reactor tube that allows conducting fluidization of the CARGEN® catalyst using the reaction gases containing GHGs to form carbon material. On the other hand, the CVD reactor configuration includes horizontal reactor tubes that facilitate the reaction on the CARGEN® catalyst (disclosed in, for example, WO2021125990A1, the entire contents of which are incorporated herein by reference) due to the flow of reaction gases through the reactor. The present disclosure, in an embodiment, relates to one or more additional apparatus auxiliary to the disclosed CARGEN® reactor configurations. These auxiliaries include but are not limited to heaters, coolers, chillers, and the mechanism to load and unload solid materials in the reactor, gas/solid separators, the furnace, the flow devices, the pressure devices, the electronics, etc.

CARGEN® Technology has demonstrated a significant advancement in the field of carbon nanotubes production, reforming for syngas production, and the utilization of the two greenhouse gases such as CO₂, and CH₄. CARGEN® Technology is essentially a combination of two reactors in parallel wherein the first reactor serves to convert CO₂ and CH₄ to syngas and carbon nanotubes as previously disclosed in, for example, U.S. Ser. No. 11/591,213B2, the entire contents of which are incorporated herein by reference, and the second reactor converts the products gases from the first reactor in a second reactor to produce tunable syngas including CO and H₂ gases. The two reactors of the CARGEN® Technology utilize two distinct catalysts that have been designed and synthesized for the selective production of carbon nanotubes in the first reactor and syngas in the second reactor. The two reactors are operated at different temperature and pressure condition benefiting from the thermodynamic benefit of product selectivity at such conditions. Previously, a catalyst tailored for the first reactor of the CARGEN® was disclosed in, for example, US20230039945A1, the entire contents of which are incorporated herein by reference. The implementation of such catalyst or other CARGEN® catalyst besides operating condition also depends upon the contact pattern and the mode of the operation. Specifically, reactors such as chemical vapor deposition (CVD) and the fluidized bed chemical vapor deposition (F-CVD) are preferred for the semi-continuous operation of the reaction system. The design of such systems requires the use of kinetics models backed with experimental and theoretical data sets. Due to the distinctive nature of the process compared to other process such as methane decomposition or more generally hydrocarbon decomposition, the design of such reactors are unique, and novel.

The present disclosure, in an embodiment, focusses on the specifics of the design of the CVD and F-CVD based CARGEN® reaction system that details the implementation of the technology, protocol, the approach to maintain continuous operation, and the geometry of the reaction system tailored for the CARGEN® system implementation.

The present disclosure generally relates to a reactor configuration, system and method for producing a carbon material and a syngas, such as, for CARGEN® technology which relates to a two-reactor system including a first reactor for producing a carbon material from a reaction feed including, for example, carbon dioxide and a volatile organic compound, such as, methane, and a second reactor for producing syngas as disclosed in, for example, US20200109050, WO2018187213, US20230039945A1, WO2021125990A1, EP4076735A1, CN115279490A, U.S. Ser. No. 11/591,213B2, and AU2018249486B2, the entire contents of which are herein incorporated by reference.

CARGEN® technology, which has been previously disclosed in U.S. Ser. No. 11/591,213B2 and AU2018249486B2, for example, represents a groundbreaking advancement in the field of natural gas reforming. This innovative process catalytically converts a greenhouse gas, such as, natural gas and carbon dioxide, into syngas and solid carbon.

Syngas, primarily composed of hydrogen and carbon monoxide, serves as a crucial raw material for the production of various high-value chemicals. Notably, it plays a significant role in the synthesis of hydrocarbon cuts, such as liquid transportation fuels via Fischer-Tropsch synthesis, as well as methanol and dimethyl ether.

On the other hand, the solid carbon produced through the CARGEN® process exists in different forms, including carbon nanotubes, carbon black, graphene, graphene oxide, and graphite. Such solid carbon serves as a vital precursor with a wide range of applications, such as, the manufacturing of cement, rubber, reinforced polymers, and concrete. Additionally, for example, such solid carbon plays a pivotal role in the electronics industry for the production of batteries, conductors, chips, and various other electronic components.

The catalyst material used in the CARGEN® process as disclosed in US20230039945A1, WO2021125990A1, EP4076735A1, and CN115279490A, for example, is specially designed to provide high activity and selectivity towards solid carbon formation, and specifically the carbon nanotubes form of carbon while lasting stability operation. The carbon nanotubes produced in the CARGEN® process follow a tip-growth mechanism in which the catalyst material is at the tip of the grown carbon nanotubes. Compared to the overall quantity of the catalyst material comprising of active metal phase and support material, only a small fraction of the active metal phase is carried along with the carbon nanotubes at its tip, and the remaining portion remains in the bulk serving sites for syngas production. After the carbon nanotubes are formed, the bulk catalyst material needs to be separated for recycling and to improve the purity of the produced carbon nanotubes. Such a process is described herein for the carbon-catalyst separation process that aligns synergistically with the catalyst and the core principles of CARGEN® technology.

The carbon catalyst separation process, in an embodiment, relates to generation/production and recovery of a highly pure carbon material (e.g., carbon nanotubes) while simultaneously enabling the recovery and recycling of the catalyst. By implementing this process, the production of a high-quality carbon material (e.g., carbon nanotubes) is achieved, fostering sustainability and resource efficiency within the CARGEN® framework according to an embodiment.

As disclosed in U.S. Ser. No. 11/591,213B2, and AU2018249486B2, for example, a two-reactor system provides enhanced carbon dioxide utilization for chemical and fuels processes, while ensuring fixation of CO₂ (e.g., the amount of CO₂ utilized is less than that generated during the process). The first reactor converts CH₄+CO₂ to solid carbon, while the second reactor converts CH₄+CO₂ to syngas using a combined reforming reaction process. In view of the global concern of greenhouse gas emissions, the present system enhances overall CO₂ fixation, unlike conventional single reactor reformer systems. From a CO₂ life cycle assessment (“LCA”) and a process integration point of view, the present subject matter facilitates CO₂ utilization in methane reforming at fixation conditions while producing both solid carbon and syngas. The latter, syngas, is an important feedstock for production of a variety of value-added chemicals, as well as ultra-clean liquid fuels.

As disclosed in U.S. Ser. No. 11/591,213B2, and AU2018249486B2, for example, a combined reforming process in the present subject matter is aimed at reacting methane (or any other volatile organic compound) with CO₂, and optionally other oxidants such as O₂, H₂O, or both to produce syngas. As provided herein, optimal operating conditions of temperature and pressure of the two reactors can be determined using a thermodynamics equilibrium analysis. Any reaction feasible thermodynamically indicates that the reaction can be carried out, given that the hurdles associated with the process are tackled via the development of an efficient catalyst and reactor orientation.

As disclosed in U.S. Ser. No. 11/591,213B2, and AU2018249486B2, for example, the present subject matter aims to maximize CO₂ fixation by optimization of the operating conditions, which could maximize carbon formation in the first reactor, i.e., the Carbon Generator Reactor (CARGEN®), in the limited presence of oxygen to drive the reaction auto-thermally. As the partial combustion or partial oxidation reaction is an exothermic reaction, the CARGEN® reactor hosts two main reactions concerning the CO₂ fixation. The first reaction includes the conversion of CO₂ to carbon. The second reaction includes a partial oxidation reaction utilizing a portion of methane (or any other volatile organic compound) for partial combustion to produce energy, among other products. The energy provided through partial oxidation reaction is more efficient than any other form of heat transfer, as this energy is generated in-situ in the process.

As disclosed in U.S. Ser. No. 11/591,213B2, and AU2018249486B2, for example, the CARGEN® reactor may be operated under low temperature and low/high pressure conditions, while the combined reformer (second reactor) may be operated at high temperature and low/high pressure conditions. By tapping the advantage of pressure and temperature swings between the two reactor units, improvements occur in both CO₂ fixation, as well as reduction in overall energy requirements of the dual reactor setup. The present subject matter also utilizes work and energy extraction processes (like turbine, expanders, etc.) associated with the change in pressure between the two reactors to overcome the pre-compression duty of the feed gas, at least partially. Thus, a unique synergism evident between the two reactors is beneficial for saving carbon credits, as well as improving sustainability of the overall process. In addition to the syngas generated from the second reactor (reformer reactor), the present process also produces solid carbon or carbonaceous material from the first reactor (CARGEN® reactor). The carbonaceous product, which is produced as a part of the CO₂ fixation process, is industrially valuable, where the carbonaceous product includes, for example, a carbon nanotube, including a multi-walled carbon nanotube. In particular, the carbonaceous product may serve as a starting material to produce many value-added chemicals that can generate substantial revenue, such as, for the process plant. Non-limiting examples of valuable chemicals include activated carbon, carbon black, carbon fiber, graphite of different grades, earthen materials, etc. This material, for example, can also be added to structural materials like cement and concrete and in road tar or in wax preparation as a part of the overall CO₂ capture process.

As disclosed in U.S. Ser. No. 11/591,213B2, and AU2018249486B2, for example, the present subject matter includes utilizing a dry reforming process to convert carbon dioxide to syngas and carbon. The present subject matter enhances CO₂ fixation using a two-reactor setup or system. The reaction scheme is divided into two processes in separate reactors in series. The first reaction targets capturing CO2 as solid carbon and the other to converting CO₂ to syngas. The present subject matter provides a systematic approach to CO₂ fixation.

As disclosed in U.S. Ser. No. 11/591,213B2, and AU2018249486B2, for example, the proposed scheme shows significant conversions of CO₂ to carbon at auto-thermal low-temperature conditions in the first reactor of the two-reactor setup. The subsequent removal of solid carbon from the system (first reactor) enhances CO₂ conversions to syngas in the second reactor by thermodynamically pushing the reaction forward. As such, the carbon from the system is removed, which is incredibly beneficial from the perspective of the CO₂ life cycle assessment (“LCA”).

There has been much research devoted to development of a novel class of catalyst targeted to resist the formation of carbon, and thus protect it from deactivation, on its surface to reduce downtime. However, such catalysts are very expensive and affect the overall economics of the process. The present subject matter as disclosed in US20230039945A1, WO2021125990A1, EP4076735A1, and CN115279490A, for example, is more economical because it instead utilizes a catalyst in the first reactor that targets or promotes carbon formation, such as carbon nanotube formation including multi-walled carbon nanotube formation. As a non-limiting example, the catalyst can include a metal including metal oxides (e.g., Fe, Ni, Co, the like and oxides thereof) and supported on a catalyst support material, such as an alumina, titania, silica, a zeolite, an inorganic clay, and the like and as further described in, for example, US20230039945A1, WO2021125990A1, EP4076735A1, and CN115279490A, which are incorporated herein by reference as previously indicated.

As disclosed in U.S. Ser. No. 11/591,213B2, and AU2018249486B2, for example, after the reaction in the first reactor, the solid carbon is filtered. The remaining product gases are fed to a higher-temperature second reactor (a combined reformer), focusing on producing high-quality syngas. Thermodynamic analysis of the results of the second reactor's operation shows no carbon formation. This drives the reaction forward at much lesser energy requirements (approximately 50 kJ less) and relatively lower temperatures in comparison to conventional reformer setups. A substantial increase in the syngas yield ratio is also seen, which is not only beneficial for syngas production for Fischer-Tropsch synthesis (requiring approximately a 2:1 H₂:CO ratio) but also for the hydrogen production (which requires high H₂:CO ratios).

As disclosed in U.S. Ser. No. 11/591,213B2, and AU2018249486B2, for example, in addition to the advantage of getting a higher H₂:CO ratio, a significant increase in the methane and carbon dioxide conversion is also seen at much lower operating temperatures. If a conventional reforming setup was used, such effects would be obtained only at higher temperatures (almost 250° C.). The advantage of removing carbon in the first reformer helps to bring down the operating temperature in the second reactor significantly. As such, the present subject matter is much more energy efficient than the conventional single reactor setup operated at higher temperatures to get similar levels of methane and carbon dioxide conversions at zero carbon deposition.

### Fluidized Bed Reactor

A vertical reactor that is placed inside a vertical furnace. The reactor is equipped with a gas flow system at its upstream to monitor and control the flow of a feed gas including for example, one or more greenhouse gases. The fluidized bed reactor is encased inside a furnace system and includes a reactor tube composed of a suitable material, such as, steel, a metal alloy, a protective internal coated metal tube, and the like. The fluidized bed reactor may have multiple heating zones and each capable to heat up to a suitable temperature, such as, up to 1000° C. temperature. The vertical reactor contains a minimum of a solid catalyst bed seated on perforated plates that allow for the flow of the feed gas. The perforation of plates, the quantity of the catalyst, size of the catalyst, and the material are parameters that can be adjusted depending on the need to fluidize and to maintain a suitable zone bed height. The multiple zones within the reactor tube have similar characteristics in terms of the perforated plates and the catalyst loading, however may also be distinct in terms of the height and the quantity of the catalyst material. The reactor tube at the top contains an entrainer, a solid/gas separator, and other suitable features that may be needed to restrict the transfer of the solids outside the reactor, and in particular, the reaction zones. The size of the reactor, the quantity of catalyst in each zone, and the number of zones depends upon the capacity of the reactor expressed in terms of the quantity of the carbon material produced (e.g., grams/day, kilograms/day, and tons/day). The downstream of the reactor may include, for example, a solid/gas separation system (e.g., electrostatic precipitators, magnetic separators, cyclones, and the like), back pressure regulators (for high pressure reactor operation). The reactor may also be provided with a provision for recycling of the reaction gases (and/or solids) as per the design need. It should be noted that any other reactor design of fluidization that fulfills the utility of the present subject matter in terms of use of fluidized bed reactor for CARGEN® technology may also be considered within the scope of the present disclosure.

### Embodiment Example Pertaining to the Design of the Fluidized Bed Reactor

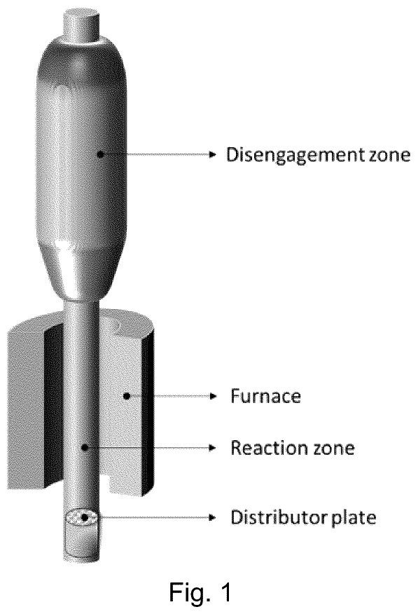

The design of the fluidized bed reactor for CARGEN® technology is described below in further detail including as illustrated in FIG. 1 according to an embodiment. To achieve fluidization, it is necessary to compute the minimum fluidization velocity, which generates sufficient upward force on the catalyst particles. The actual fluidization velocity exceeds this calculated range. For CARGEN® Technology, the requirement for multiple feed gases to be mixed in a specific ratio, as specified in prior application U.S. Ser. No. 11/591,213B2, necessitates a total flow that ensures an effective gas velocity above the minimum fluidization condition. Whereas the lumped kinetics model presented in this section presents the CARGEN® kinetics model that is built based on nine interlinked reaction networks. Presented below is a step-by-step procedure for calculating the minimum fluidization velocity as well as the kinetics of the CARGEN® process, which is adhered to in this example. The design of the fluidized bed reactor, in an embodiment of the present disclosure, for CARGEN® Technology, is based on these calculations, along with the thermodynamic calculations provided in U.S. Ser. No. 11/591,213B2.

### Procedure for Fluidization Velocity Calculations:

Step 1: Solving Ergun equation (Macdonald, I. F., et al. Industrial & Engineering Chemistry Fundamentals 18.3 (1979): 199-208). for pressure drop:

$$\frac{Δ P}{h} = {ρ}_{g} {U}^{2} \frac{[ \frac{\text{?}}{\text{?}} + \frac{7}{4} ] ( 1 - \text{?} )}{φ {d}_{p} \text{?}}$$

$$Where ,$$

$$Δ P = Pressure drop$$

$$h = height of the bed$$

$${ρ}_{g} = density of the gas$$

$$U = gas velocity$$

$$ϵ = bed voidage \text{?}$$

$${Re}_{d} = Reynolds number$$

$$φ = shape factor of the catalyst or sphericity$$

$$\text{?} = area of cross - section$$

$$\text{?} \text{indicates text missing or illegible when filed}$$

Step 2: Calculating the mass of the solids by balancing the upward drag force with the gravitational force:

Wₛ = ρ_{c}A_{c}hₛ(1 − ϵₛ) = ρ_{c}A_{c}h(1 − ϵ)
where,
ρ_{c} = density of the catalyst
A_{c} = area of cross-section of the bed
hₛ = height of the un-fluidized bed
ϵₛ = porosity of the un-fluidized bed
Also, at minimum fluidization, the weight of the bed equals the pressure drop, therefore,
$( \frac{Δ P}{h} ) = g η ( 1 - {ϵ}_{mf} )$
where.
η = g(ρ_{c} − ρ_{g})
Wₛ = ΔPA_{c}
After rearranging:
$g ( 1 - ϵ ) ( {ρ}_{c} - {rho}_{g} ) {hA}_{c} = \text{?} {A}_{c} h$
$For {Re}_{p} = \frac{{ρ}_{g} {d}_{p} U}{μ} < 10 , equation ( 6 ) is solved to get the minimum fluidization velocity ( U =$
U_{mf}, and ϵ = ϵ_{mf}):
${u}_{mf} = \frac{{( φ {d}_{p} )}^{2}}{150 μ} [ g ( {ρ}_{c} - {ρ}_{g} ) ] ( \frac{{ϵ}_{mf}^{3}}{1 - {ϵ}_{mf}} )$
Broadhurst et al. (Broadhurst, T.E., and H.A. Becker, AlChE Journal 21.2 (1975): 238-
247.) presents a reasonably accurate (within 10%):
${ϵ}_{mf} = 0.586 \times {φ}^{- 0.72} \times {( \frac{{μ}^{2}}{g \times η \times {d}_{p}^{3}} )}^{0.029} {( \frac{{ρ}_{g}}{{ρ}_{c}} )}^{0.021}$
$\text{?} \text{indicates text missing or illegible when filed}$

Utilizing the concept, minimum fluidization velocity and the fluidization conditions were determined for the CARGEN® reactor operation in the fluidized bed reactor. Table 1 below presents the various data points generated under various conditions showcasing the conditions of fluidization and the minimum flow of the gases needed.

Visual basic code of the fluidized bed reactor:

The following visual basic code has been written in Microsoft Excel Visual Basic Macros to execute the calculations at multiple conditions:

Sub fluidized_bed( )
Dim shi, rho_g, rho_c, mu, g, d, dp, h, alpha, v0 As Double
Dim eta, Ac, Emf, Umf, d_b, d_bm, d_b0, u_b, del, Ws As Double
′ Read input values from linked Excel cells
shi = Range(″B1″).Value
rho_g = Range(″B2″).Value
rho_c = Range(″B3″).Value
mu = Range(″B4″).Value
g = Range(″B5″).Value
d = Range(″B6″).Value
dp = Range(″B7″).Value
h = Range(″B8″).Value
alpha = Range(″B9″).Value
v0 = Range(″B10″).Value
′ Calculate parameters
eta = g * (rho_c − rho_g)
Range(″b11″).Value = eta
Ac = WorksheetFunction.Pi( ) * (d / 2) \hat{ } 2
Range(″b12″).Value = Ac
u0 = v0 / Ac
Range(″b13″).Value = u0
Emf = 0.586 * shi \hat{ } (−0.72) * (mu \hat{ } 2 / rho_g / eta / dp \hat{ } 3) \hat{ } 0.029 * (rho_g / rho_c) \hat{ } 0.021
Range(″b14″).Value = Emf
Umf = ((shi * dp) \hat{ } 2) / 150 * eta / mu * (Emf \hat{ } 3) / (1 − Emf)
′Umf = ((0.7 * 0.01) \hat{ } 2) / 150 * 1272 / 0.00015 * (0.58 \hat{ } 3) / (1 − 0.58)
Range(″b15″).Value = Umf
d_bm = 0.652 * Ac \hat{ } 0.4 * (u0 − Umf) \hat{ } 0.4
d_bm = Int(d_bm)
Range(″b16″).Value = d_bm
d_b0 = 0.000376 * (u0 − Umf) \hat{ } 2
Range(″b17″).Value = d_b0
d_b = 34.2 * (1 − Exp(−0.3 * h / 2 / d))|
Range(″b18″).Value = Int(d_b)
u_b = u0 − Umf + 0.71 * (g * d_b) \hat{ } 0.5
Range(″b19″).Value = u_b
del = (u0 − Umf) / (u_b − Umf * (1 + alpha))
Range(″b20″).Value = del
Ws = Ac * h * (1 − del) * (1 − Emf) * rho_c
Range(″b21″).Value = Ws
End Sub

TABLE 1
Data points generated at various flow conditions of the CARGEN ® Fluidized bed reactor.

| | | | | | | | | | | Target |
|---|---|---|---|---|---|---|---|---|---|---|
| | | | | | | | | | STP | gas |
| | | | | acceleration | | | | | total | volume |
| | gas | particle | fluid | due to | bed | particle | bed | | flow | to be |
| | density, | density, | viscosity, | gravity, | diameter, | diameter, | height, | Ergun | of gas | processed, |
| Sphericity | g/cm3 | g/cm3 | poise | cm/s2 | cm | cm | cm | parameter | (mL/min) | cm3/s |
| 0.7 | 0.0 | 2.0 | 0.0 | 980.0 | 1.4 | 0.0 | 100.0 | 0.2 | 200.0 | 3.3 |
| 0.7 | 0.0 | 1.3 | 0.0 | 980.0 | 5.1 | 0.0 | 114.0 | 0.2 | 300.0 | 5.0 |
| 0.7 | 0.0 | 1.3 | 0.0 | 980.0 | 5.1 | 0.0 | 114.0 | 0.2 | 400.0 | 6.7 |
| 0.7 | 0.0 | 1.3 | 0.0 | 980.0 | 5.1 | 0.0 | 114.0 | 0.2 | 500.0 | 8.3 |
| 0.7 | 0.0 | 1.3 | 0.0 | 980.0 | 5.1 | 0.0 | 114.0 | 0.2 | 600.0 | 10.0 |
| 0.7 | 0.0 | 1.3 | 0.0 | 980.0 | 5.1 | 0.0 | 114.0 | 0.2 | 700.0 | 11.7 |
| 0.7 | 0.0 | 1.3 | 0.0 | 980.0 | 5.1 | 0.0 | 114.0 | 0.2 | 800.0 | 13.3 |
| 0.7 | 0.0 | 1.3 | 0.0 | 980.0 | 5.1 | 0.0 | 114.0 | 0.2 | 900.0 | 15.0 |
| 0.7 | 0.0 | 1.3 | 0.0 | 980.0 | 5.1 | 0.0 | 114.0 | 0.2 | 1000.0 | 16.7 |
| 0.7 | 0.0 | 1.3 | 0.0 | 980.0 | 5.1 | 0.0 | 114.0 | 0.2 | 1100.0 | 18.3 |
| 0.7 | 0.0 | 1.3 | 0.0 | 980.0 | 5.1 | 0.0 | 114.0 | 0.2 | 1200.0 | 20.0 |
| 0.7 | 0.0 | 1.3 | 0.0 | 980.0 | 5.1 | 0.0 | 114.0 | 0.2 | 1300.0 | 21.7 |
| 0.7 | 0.0 | 1.3 | 0.0 | 980.0 | 5.1 | 0.0 | 114.0 | 0.2 | 1400.0 | 23.3 |
| 0.7 | 0.0 | 1.3 | 0.0 | 980.0 | 5.1 | 0.0 | 114.0 | 0.2 | 1500.0 | 25.0 |
| 0.7 | 0.0 | 1.3 | 0.0 | 980.0 | 5.1 | 0.0 | 114.0 | 0.2 | 1600.0 | 26.7 |
| 0.7 | 0.0 | 1.3 | 0.0 | 980.0 | 5.1 | 0.0 | 114.0 | 0.2 | 1700.0 | 28.3 |
| 0.7 | 0.0 | 1.3 | 0.0 | 980.0 | 5.1 | 0.0 | 114.0 | 0.2 | 1800.0 | 30.0 |
| 0.7 | 0.0 | 1.3 | 0.0 | 980.0 | 5.1 | 0.0 | 114.0 | 0.2 | 1900.0 | 31.7 |
| 0.7 | 0.0 | 1.3 | 0.0 | 980.0 | 5.1 | 0.0 | 114.0 | 0.2 | 2000.0 | 33.3 |
| 0.7 | 0.0 | 1.3 | 0.0 | 980.0 | 5.1 | 0.0 | 114.0 | 0.2 | 2100.0 | 35.0 |
| 0.7 | 0.0 | 1.3 | 0.0 | 980.0 | 5.1 | 0.0 | 114.0 | 0.2 | 2200.0 | 36.7 |
| 0.7 | 0.0 | 1.3 | 0.0 | 980.0 | 5.1 | 0.0 | 114.0 | 0.2 | 2300.0 | 38.3 |
| 0.7 | 0.0 | 1.3 | 0.0 | 980.0 | 5.1 | 0.0 | 114.0 | 0.2 | 2400.0 | 40.0 |
| 0.7 | 0.0 | 1.3 | 0.0 | 980.0 | 5.1 | 0.0 | 114.0 | 0.2 | 2500.0 | 41.7 |
| 0.7 | 0.0 | 1.3 | 0.0 | 980.0 | 5.1 | 0.0 | 114.0 | 0.2 | 2600.0 | 43.3 |
| 0.7 | 0.0 | 1.3 | 0.0 | 980.0 | 5.1 | 0.0 | 114.0 | 0.2 | 2700.0 | 45.0 |
| 0.7 | 0.0 | 1.3 | 0.0 | 980.0 | 5.1 | 0.0 | 114.0 | 0.2 | 2800.0 | 46.7 |
| 0.7 | 0.0 | 1.3 | 0.0 | 980.0 | 5.1 | 0.0 | 114.0 | 0.2 | 2900.0 | 48.3 |
| 0.7 | 0.0 | 1.3 | 0.0 | 980.0 | 5.1 | 0.0 | 114.0 | 0.2 | 3000.0 | 50.0 |
| 0.7 | 0.0 | 1.3 | 0.0 | 980.0 | 5.1 | 0.0 | 114.0 | 0.2 | 3100.0 | 51.7 |
| 0.7 | 0.0 | 1.3 | 0.0 | 980.0 | 5.1 | 0.0 | 114.0 | 0.2 | 3200.0 | 53.3 |
| 0.7 | 0.0 | 1.3 | 0.0 | 980.0 | 5.1 | 0.0 | 114.0 | 0.2 | 3300.0 | 55.0 |
| 0.7 | 0.0 | 1.3 | 0.0 | 980.0 | 5.1 | 0.0 | 114.0 | 0.2 | 3400.0 | 56.7 |
| 0.7 | 0.0 | 1.3 | 0.0 | 980.0 | 5.1 | 0.0 | 114.0 | 0.2 | 3500.0 | 58.3 |
| 0.7 | 0.0 | 1.3 | 0.0 | 980.0 | 5.1 | 0.0 | 114.0 | 0.2 | 3600.0 | 60.0 |
| 0.7 | 0.0 | 1.3 | 0.0 | 980.0 | 5.1 | 0.0 | 114.0 | 0.2 | 3700.0 | 61.7 |
| 0.7 | 0.0 | 1.3 | 0.0 | 980.0 | 5.1 | 0.0 | 114.0 | 0.2 | 3800.0 | 63.3 |
| 0.7 | 0.0 | 1.3 | 0.0 | 980.0 | 5.1 | 0.0 | 114.0 | 0.2 | 3900.0 | 65.0 |
| 0.7 | 0.0 | 1.3 | 0.0 | 980.0 | 5.1 | 0.0 | 114.0 | 0.2 | 4000.0 | 66.7 |
| 0.7 | 0.0 | 1.3 | 0.0 | 980.0 | 5.1 | 0.0 | 114.0 | 0.2 | 4100.0 | 68.3 |

| | | | | | | | | | Maximum |
|---|---|---|---|---|---|---|---|---|---|
| | | | | | Minimum | | Amount | | velocity |
| | | Cross- | Superficial | Porosity | Fluidization | Can | of solid | | through |
| | Eta = | sectional | velocity, | at minimum | Velocity, | fluidization | holdup, | | the bed, |
| | g*(rho_c − | area, | u0, | fluidization, | Umf, | be achieved? | Ws, | | ut, |
| Sphericity | rho_g) | Ac, (cm2) | [symbol] | Emf | cm/s | (Umf > u0) | grams | Re | [symbol] |
| 0.7 | 1959.3 | 1.5 | 2.2 | 0.6 | 2.2 | NO | 135.5 | 0.1 | 94.7 |
| 0.7 | 1273.3 | 20.4 | 0.2 | 0.6 | 1.6 | NO | 1309.2 | 0.0 | 61.5 |
| 0.7 | 1273.3 | 20.4 | 0.3 | 0.6 | 1.6 | NO | 1308.3 | 0.0 | 61.5 |
| 0.7 | 1273.3 | 20.4 | 0.4 | 0.6 | 1.6 | NO | 1307.4 | 0.0 | 61.5 |
| 0.7 | 1273.3 | 20.4 | 0.5 | 0.6 | 1.6 | NO | 1306.6 | 0.0 | 61.5 |
| 0.7 | 1273.3 | 20.4 | 0.6 | 0.6 | 1.6 | NO | 1305.7 | 0.0 | 61.5 |
| 0.7 | 1273.3 | 20.4 | 0.7 | 0.6 | 1.6 | NO | 1304.9 | 0.0 | 61.5 |
| 0.7 | 1273.3 | 20.4 | 0.7 | 0.6 | 1.6 | NO | 1304.0 | 0.0 | 61.5 |
| 0.7 | 1273.3 | 20.4 | 0.8 | 0.6 | 1.6 | NO | 1303.2 | 0.1 | 61.5 |
| 0.7 | 1273.3 | 20.4 | 0.9 | 0.6 | 1.6 | NO | 1302.3 | 0.1 | 61.5 |
| 0.7 | 1273.3 | 20.4 | 1.0 | 0.6 | 1.6 | NO | 1301.5 | 0.1 | 61.5 |
| 0.7 | 1273.3 | 20.4 | 1.1 | 0.6 | 1.6 | NO | 1300.6 | 0.1 | 61.5 |
| 0.7 | 1273.3 | 20.4 | 1.1 | 0.6 | 1.6 | NO | 1299.8 | 0.1 | 61.5 |
| 0.7 | 1273.3 | 20.4 | 1.2 | 0.6 | 1.6 | NO | 1298.9 | 0.1 | 61.5 |
| 0.7 | 1273.3 | 20.4 | 1.3 | 0.6 | 1.6 | NO | 1298.1 | 0.1 | 61.5 |
| 0.7 | 1273.3 | 20.4 | 1.4 | 0.6 | 1.6 | NO | 1297.2 | 0.1 | 61.5 |
| 0.7 | 1273.3 | 20.4 | 1.5 | 0.6 | 1.6 | NO | 1296.4 | 0.1 | 61.5 |
| 0.7 | 1273.3 | 20.4 | 1.5 | 0.6 | 1.6 | NO | 1295.6 | 0.1 | 61.5 |
| 0.7 | 1273.3 | 20.4 | 1.6 | 0.6 | 1.6 | YES | 1294.7 | 0.1 | 61.5 |
| 0.7 | 1273.3 | 20.4 | 1.7 | 0.6 | 1.6 | YES | 1293.9 | 0.1 | 61.5 |
| 0.7 | 1273.3 | 20.4 | 1.8 | 0.6 | 1.6 | YES | 1293.0 | 0.1 | 61.5 |
| 0.7 | 1273.3 | 20.4 | 1.9 | 0.6 | 1.6 | YES | 1292.2 | 0.1 | 61.5 |
| 0.7 | 1273.3 | 20.4 | 2.0 | 0.6 | 1.6 | YES | 1291.4 | 0.1 | 61.5 |
| 0.7 | 1273.3 | 20.4 | 2.0 | 0.6 | 1.6 | YES | 1290.5 | 0.1 | 61.5 |
| 0.7 | 1273.3 | 20.4 | 2.1 | 0.6 | 1.6 | YES | 1289.7 | 0.1 | 61.5 |
| 0.7 | 1273.3 | 20.4 | 2.2 | 0.6 | 1.6 | YES | 1288.9 | 0.1 | 61.5 |
| 0.7 | 1273.3 | 20.4 | 2.3 | 0.6 | 1.6 | YES | 1288.0 | 0.1 | 61.5 |
| 0.7 | 1273.3 | 20.4 | 2.4 | 0.6 | 1.6 | YES | 1287.2 | 0.1 | 61.5 |
| 0.7 | 1273.3 | 20.4 | 2.4 | 0.6 | 1.6 | YES | 1286.4 | 0.2 | 61.5 |
| 0.7 | 1273.3 | 20.4 | 2.5 | 0.6 | 1.6 | YES | 1285.6 | 0.2 | 61.5 |
| 0.7 | 1273.3 | 20.4 | 2.6 | 0.6 | 1.6 | YES | 1284.7 | 0.2 | 61.5 |
| 0.7 | 1273.3 | 20.4 | 2.7 | 0.6 | 1.6 | YES | 1283.9 | 0.2 | 61.5 |
| 0.7 | 1273.3 | 20.4 | 2.8 | 0.6 | 1.6 | YES | 1283.1 | 0.2 | 61.5 |
| 0.7 | 1273.3 | 20.4 | 2.9 | 0.6 | 1.6 | YES | 1282.3 | 0.2 | 61.5 |
| 0.7 | 1273.3 | 20.4 | 2.9 | 0.6 | 1.6 | YES | 1281.4 | 0.2 | 61.5 |
| 0.7 | 1273.3 | 20.4 | 3.0 | 0.6 | 1.6 | YES | 1280.6 | 0.2 | 61.5 |
| 0.7 | 1273.3 | 20.4 | 3.1 | 0.6 | 1.6 | YES | 1279.8 | 0.2 | 61.5 |
| 0.7 | 1273.3 | 20.4 | 3.2 | 0.6 | 1.6 | YES | 1279.0 | 0.2 | 61.5 |
| 0.7 | 1273.3 | 20.4 | 3.3 | 0.6 | 1.6 | YES | 1278.2 | 0.2 | 61.5 |
| 0.7 | 1273.3 | 20.4 | 3.3 | 0.6 | 1.6 | YES | 1277.3 | 0.2 | 61.5 |

[symbol]

indicates data missing or illegible when filed

CARGEN® Kinetics:

The following are the nine primary reactions that take place within the first reactor between CO₂, O₂, H₂O, CH₄, CO, H₂, and solid carbon:

$$\begin{matrix}R1 & \\ {CH}_{4} + {H}_{2} O ↔ CO + 3 {H}_{2} & \end{matrix}$$

$$Δ \text{?} = 206 \frac{\text{?}}{mol}$$

$$\begin{matrix}R2 & \\ CO + {H}_{2} O ↔ {CO}_{2} + {H}_{2} & \end{matrix}$$

$$Δ \text{?} = - 41.2 \frac{\text{?}}{mol}$$

$$\begin{matrix}R3 & \\ {CH}_{4} + 2 {H}_{2} O ↔ {CO}_{2} + 4 {H}_{2} & \end{matrix}$$

$$Δ \text{?} = 164.9 \frac{\text{?}}{mol}$$

$$\begin{matrix}R4 & \\ {CH}_{4} + {CO}_{2} ↔ 2 CO + 2 {H}_{2} & \end{matrix}$$

$$Δ \text{?} = 247 \frac{\text{?}}{mol}$$

$$\begin{matrix}R5 & \\ {CH}_{4} + \frac{1}{2} {O}_{2} ↔ CO + 2 {H}_{2} & \end{matrix}$$

$$Δ \text{?} = - 35 \frac{\text{?}}{mol}$$

$$\begin{matrix}R6 & \\ {CH}_{4} + 2 {O}_{2} ↔ {CO}_{2} + 2 {H}_{2} O & \end{matrix}$$

$$Δ \text{?} = - 802.7 \frac{\text{?}}{mol}$$

$$\begin{matrix}R7 & \\ {CH}_{4} ↔ C + 2 {H}_{2} & \end{matrix}$$

$$Δ \text{?} = 74.8 \frac{\text{?}}{mol}$$

$$\begin{matrix}R8 & \\ CO + {H}_{2} ↔ C + {H}_{2} O & \end{matrix}$$

$$Δ \text{?} = - 131.33 \frac{\text{?}}{mol}$$

$$\begin{matrix}R9 & \\ 2 CO ↔ C + {CO}_{2} & \end{matrix}$$

$$Δ \text{?} = - 175.52 \frac{\text{?}}{mol}$$

$$\text{?} \text{indicates text missing or illegible when filed}$$

The lumped kinetics model pertaining to each of the equations above is provided below:

$${r}_{1} [ \frac{mol}{\text{?}} ] = \frac{\text{?} ( \text{?} \frac{\text{?}}{\text{?}} )}{{( DEN )}^{2}}$$

$${r}_{2} [ \frac{mol}{\text{?}} ] = \frac{\text{?} ( \text{?} \frac{\text{?}}{\text{?}} )}{{( DEN )}^{2}}$$

$${r}_{3} [ \frac{mol}{\text{?}} ] = \frac{\text{?} ( \text{?} \frac{\text{?}}{\text{?}} )}{{( DEN )}^{2}}$$

$${r}_{4} [ \frac{mol}{\text{?}} ] = \frac{\text{?}}{\text{?}}$$

$${r}_{5} \& {r}_{6} [ \frac{mol}{\text{?}} ] = \frac{\text{?}}{1 + \text{?}} + \frac{\text{?}}{1 + \text{?}}$$

$${r}_{7} [ \frac{mol}{\text{?}} ] = \frac{\text{?} ( \text{?} \frac{\text{?}}{\text{?}} )}{{( DEN 2 )}^{2}}$$

$${r}_{8} [ \frac{mol}{\text{?}} ] = \frac{\text{?} ( \text{?} \frac{\text{?}}{\text{?}} )}{{( DEN 2 )}^{2}}$$

$${r}_{9} [ \frac{mol}{\text{?}} ] = \frac{\text{?} ( \text{?} \frac{\text{?}}{\text{?}} )}{{( DEN 3 )}^{2}}$$

$$DEN = 1 + {K}_{CO} {p}_{CO} + {K}_{{H}_{2}} {p}_{{H}_{2}} + {K}_{{CH}_{3}} {p}_{{CH}_{4}} + \frac{\text{?}}{\text{?}}$$

$$DEN 2 = 1 + {K}_{CO} {p}_{CO} + {\tilde{K}}_{{CH}_{3}} {p}_{{CH}_{4}} + \frac{\text{?}}{\text{?}} \text{?} + \frac{\text{?}}{\text{?}} \frac{\text{?}}{\text{?}}$$

$$DEN 3 = 1 + \text{?} {p}_{CO} + \frac{1}{\text{?}} \frac{\text{?}}{\text{?}}$$

$$\text{?} \text{indicates text missing or illegible when filed}$$

TABLE 2
List of parameters used in the kinetic equations:

| Parameter | Expression | Unit |
|---|---|---|
| k₁ | $4.225 \times 1 {0}^{15} \cdot {e}^{( \frac{- 240100}{RT} )}$ | $\frac{mol \cdot {bar}^{0.5}}{g \cdot h}$ |
| k₂ | $1.955 \times 1 {0}^{6} \cdot {e}^{( \frac{- 67130}{RT} )}$ | $\frac{mol}{g \cdot h \cdot bar}$ |
| k₃ | $1.020 \times 1 {0}^{15} \cdot {e}^{( \frac{- 243900}{RT} )}$ | $\frac{mol \cdot {bar}^{0.5}}{g \cdot h}$ |
| K₁ | ${e}^{( \frac{- 11650}{T} + 13.076 )}$ | bar² |
| K₂ | ${e}^{( \frac{1910}{T} - 1.764 )}$ | — |
| K₃ | ${e}^{( \frac{- 9740}{T} + 11.312 )}$ | bar² |
| K_{CO} | $8.23 \times 1 {0}^{- 5} \cdot {e}^{( \frac{70650}{RT} )}$ | bar⁻¹ |
| K_{H}_{₂} | $6.12 \times 1 {0}^{- 9} \cdot {e}^{( \frac{82900}{RT} )}$ | bar⁻¹ |
| K_{CH}_{₄} | $6.65 \times 1 {0}^{- 4} \cdot {e}^{( \frac{38280}{RT} )}$ | bar⁻¹ |
| K_{H}_{₂}_{O} | $1.77 \times 1 {0}^{5} \cdot {e}^{( \frac{- 88680}{RT} )}$ | — |
| k_{M}⁺ | $5.5619 \times 1 {0}^{4} \cdot {e}^{( \frac{- 65053}{RT} )}$ | $\frac{mol}{g \cdot h}$ |
| k_{O}⁻ | $1.33 \times 1 {0}^{- 6} \cdot {e}^{( \frac{75955}{RT} )}$ | $\frac{mol}{g \cdot h}$ |
| k_{O}⁺′ | $1.67 \times 1 {0}^{9} \cdot {e}^{( \frac{- 148916}{RT} )}$ | $\frac{mol}{g \cdot h}$ |
| k_{B}⁺ | $2.673 \times 1 {0}^{7} \cdot {e}^{( \frac{- 108379}{RT} )}$ | $\frac{mol}{g \cdot h}$ |
| K_{CO-B} | ${e}^{( \frac{- 115}{R} )} \times {e}^{( \frac{92543}{RT} )}$ | bar⁻¹ |
| k_{B}* | ${e}^{( \frac{- 170.44}{R} )} \times {e}^{( \frac{162483}{RT} )}$ | bar⁻¹ |
| \tilde{K}_{CH}_{₄} | 0.1099 | bar⁻¹ |
| K_{M}^{≠} | ${e}^{( \frac{142.5}{R} )} \times {e}^{( \frac{- 123226}{RT} )}$ | — |
| K_{O,H}_{₂}_{O} | $1.7372 \times 1 {0}^{4} \cdot {e}^{( \frac{- 60615}{RT} )}$ | — |
| Kᵣ″ | $2.51893 \times 1 {0}^{5} \cdot {e}^{( \frac{- 95489}{RT} )}$ | bar^{1.5} |
| K_{O,CO}_{₂} | $3.0190322 \times 1 {0}^{7} \cdot {e}^{( \frac{- 89805}{RT} )}$ | bar |
| K₁′k₂′ | $2.61 \times 1 {0}^{- 3} \cdot {e}^{( \frac{- 4300}{T} )}$ | $\frac{mol}{g \cdot s \cdot k Pa}$ |
| K₃′ | $5.17 \times 1 {0}^{- 5} \cdot {e}^{( \frac{8700}{T} )}$ | bar⁻¹ |
| k₄ | $5.35 \times 1 {0}^{- 1} \cdot {e}^{( \frac{- 7500}{T} )}$ | $\frac{mol}{g \cdot h}$ |

Embodiment pertaining to the experimental CARGEN® Fluidized bed reactor:

In a non-limiting example presented here, in a typical fluidized bed reaction campaign, a catalyst loading of approximately 0.5-1 g is employed. This catalyst predominantly consists of nickel metal supported on alumina; however, alternative compositions are viable. These include other metals such as iron, cobalt, rhodium, ruthenium, or mixed metal oxides like cobalt/magnesium oxide, iron/cerium dioxide, tungsten trioxide-zirconium dioxide, as well as potassium carbonate, calcium oxide supported on activated carbon, titanium dioxide, alumina, silica, or carbon nanofibers, all serving as active catalysts.

Beyond their chemical characteristics, the catalysts must possess specific physical attributes to meet the hydrodynamic requirements of the fluidized bed reaction, particularly for the CARGEN® reaction. These critical physical characteristics include a high surface area of at least 100 m²/g, pronounced porosity of at least 0.02 g/cm³, classification within the Geldeart system as Group B, and a particle diameter ranging approximately from 60 to 200 μm. These physical features are essential for facilitating efficient fluidization, ensuring optimal mass transfer, and promoting desirable reaction kinetics within the fluidized bed reactor system.

The fluidization of both the catalyst and the carbon grown on it can be achieved using either a quartz reactor tube or a metal reactor tube. The quartz reactor tube must possess high-temperature stability, typically around 1000-1200° C., and withstand pressures of approximately 1 atm. Conversely, the metal reactor tube should withstand temperatures of around 1000° C. and pressures of 5 atm or higher.

Precise temperature control is crucial within the reactor and at the reactor tube's surface to ensure the quality of the carbon products. This is typically achieved using thermocouples, allowing for accurate monitoring and adjustment of local temperatures.

Both types of reactor tubes should comprise two distinct zones: the lower zone, designated as the reaction zone, and the upper zone, designated as the disengagement zone. The reaction zone initiates the carbon deposition process and typically has a slightly smaller diameter, while the disengagement zone, positioned above it, should be slightly larger. This design facilitates optimal fluidization dynamics and ensures efficient separation of the reaction products from the catalyst bed.

The reaction zone of the reactor must maintain a lower temperature, typically around 450-550° C., to facilitate carbon nucleation on the catalyst surface through the diffusion of gaseous carbon sources. This temperature range enables enhanced precipitation of solid carbon. Within the lower zone of the reactor, provision should be made for the installation of porous plates, commonly referred to as distributor plates. These plates serve multiple functions: they facilitate the loading of fresh catalyst onto them, and they allow the reacting gases to flow in an updraft manner, aiding in the fluidization of the reaction media. The porosity of the distributor plate and the diameter of the reactor tube play crucial roles in controlling the hydrodynamics of the fluidized bed reactor. In a typical CARGEN® fluidized bed reactor, the tube diameter in the reaction zone may range from 2 to 3 cm, while the pores of the distributor plate can vary from 10 to 100 μm. The diameter of the disengagement zone, positioned above the reaction zone, may range from 3 to 6 cm.

During a specific reaction run, the fresh catalyst must undergo in situ reduction, achieved with pure H₂, CO gas, or a mixture of H₂ and CO in an inert gas environment, at temperatures ranging from 500 to 800° C. When pure H₂ gas is employed, the reduction temperature should not exceed 550° C. The flow rate of the reducing gas should be maintained at 2000 mL/g_{cat}/min for approximately 60 minutes. Following reduction, the reactor must be purged with an inert gas, such as N₂, to eliminate any spillover and unreacted hydrogen, which may adversely affect the CARGEN® reaction. Care must be taken during purging to prevent passivation of the catalyst particles.

Subsequently, the reaction mixture containing CH₄, CO₂, and O₂/air should be fed into the reactor at a flow rate of 2000-5000 mL/g_{cat}/min, at the desired reaction temperature of approximately 450-500° C. The temperature of the disengagement zone should be maintained at no more than 100° C. above that of the reaction zone.

During a specific reactor run, the catalyst particles should spend at least 50% of the residence time in the reaction zone before being transferred to the disengagement zone for refinement. Continuous monitoring of the reaction is essential, typically achieved using gas chromatography (GC) instruments such as thermal conductivity detectors (TCD-GC), micro-GC, or residual gas analyzers. The progression of the reaction can be monitored by observing the concentrations of evolved gases such as CO and H₂.

Care should be taken to prevent overfilling of the reactor tube with carbon. Finally, the reactor can be cooled down under a flow of reactive gas until it reaches 300° C. Subsequently, the reactive gas flow should be suspended, and inert gas, such as N₂, should be used to purge the reactor tube. GC analysis should then be conducted to confirm the absence of trace amounts of CO and H₂ in the reactor. Sampling of the solid carob can be performed once the internal temperature of the reactor reaches 50° C. or lower.

### Chemical Vapor Deposition Reactor

A chemical vapor deposition reaction system includes a reactor tube composed of a suitable material (e.g., high temperature quartz, steel, a metal alloy, a protective internal coated metal tube, etc.) placed inside a suitable furnace. The furnace can be heated either directly using resistance heating (e.g., electric powered) or is placed inside a high temperature furnace. The furnace may include a live flame due to combustion, for example, of one or more of natural gas, hydrogen gas, propane gas, naphtha gas, off gases, tail gases, flue gases, or any other type of combustible gases. The overall configuration would allow the reaction gas or gases to be fed in from one side and the product gas or gases to be produced from the other side of the reactor. The configuration also allows for cooling water jackets at the reactor tube ends and flanges to maintain safe temperature during reactor operation. There is also a mechanism to load and unload the catalyst material and carbon material within the reactor tubes. The overall configuration of the chemical vapor deposition reactor enables placement of multiple reactor tubes of various diameters and lengths that suits the scale of carbon material production. Additionally, the configuration includes a feed section that includes various mass flow controllers of capacity ranges suiting the scale of carbon production. The feed section also includes, for example, pressure control valves, non-return valves, and transducers. At the product side, the configuration includes, for example, back pressure regulators for high pressure operation, pressure safety valves, non-return valves, mechanism to separate water produced during reaction, and finally the exit gas post treatment section that would enable flow of gases either to vent or to the next reactor or process unit.

### Embodiment Example Pertaining to the Design Development of the Chemical Vapor Deposition Reactor

In a non-limiting example presented herein, a MATLAB® code developed to implement the lumped kinetics model of the CARGEN® reactor. The following ordinary differential equations programmed in MATLAB® are solved simultaneously using the ODE15S solver:

$\frac{\text{?}}{dW} = - {r}_{1} - {r}_{3} - {r}_{4} - {r}_{6} - {r}_{7}$
$\frac{\text{?}}{dW} = {r}_{2} + {r}_{3} - {r}_{4} + {r}_{6} + {r}_{9}$
$\frac{\text{?}}{dW} = - 2 {r}_{6}$
$\frac{\text{?}}{dW} = - {r}_{1} - {r}_{2} - 2 {r}_{3} + 2 {r}_{6} + {r}_{8}$
$\frac{\text{?}}{dW} = 0$
$\frac{\text{?}}{dW} = {r}_{1} - {r}_{2} + 2 {r}_{4} - 2 {r}_{9}$
$\frac{\text{?}}{dW} = 3 {r}_{1} + {r}_{2} + 4 {r}_{3} + 2 {r}_{4} + 2 {r}_{7} - {r}_{8}$
$\frac{\text{?}}{dW} = {r}_{7} + {r}_{8} + {r}_{9}$
where,
F: molar flow rate of the component [mol/h],
r: reaction rate (mol/g/h],
W: weight of the catalyst [g]
The temperature profile of the CVD reactor is evaluated using the follow-
ing energy balance equation for isothermal reactions:
$\frac{dT}{dW} = \text{?}$
where,
U: heat transfer coefficient, approximated as 1,000 [J/m²h/K],
a: heat exchange surface area per unit volume [1/m] = 4/D,
T: the reaction temperature [K],
T_{α}: the ambient temperature or jacket temperature [K],
W: the weight of the catalyst [g],
D: the diameter of the reactor tube [m],
ρ_{b}: the density of the bed [g/cm³],
i: the reaction number,
j: the component number,
q: total number of reactions,
m: the total number of components,
n: the reaction rates [mol/g/h],
ΔHᵣₓₙ_{ᵢ}(T): in [j/mol] is the heat of reaction as a function of temperature,
Fⱼ: is the molar flow rate of the component [mol/h],
Cₚ_{ⱼ}: is the heat capacity of the component as a function of temperature
[j/mol/K].
$\text{?} \text{indicates text missing or illegible when filed}$

### Momentum Balance

The momentum balance is accounted for in terms of pressure drop using the following Ergun equation:

$\frac{dP}{dW} = - \frac{{β}_{0}}{10 {A}_{t} {ρ}_{b}} ( \frac{{P}_{tot 0}}{P} ) \frac{T}{{T}_{0}} \frac{{F}_{tot}}{{F}_{tot 0}}$
where,
B₀: constant,
Aₜ: cross-sectional area of reactor tube [m²],
ρ_{_{b}}; the bulk density of the catalyst;
Pₜₒₜ₀: the initial total pressure inside the reactor tube [Bar],
P: the total pressure inside reactor tube [Bar],
T: the temperature inside reactor tube [K],
T₀: the initial temperature at the reactor inlet [K],
Fₜₒₜ: the total molar flow rate inside the reactor tube [mol/h], and
Fₜₒₜ₀: the initial total molar flow rate at reactor inlet [mol/h]

The weight (W) of the catalyst represents an independent variable that is solved using ordinary differential equations of mass, energy, and momentum. The limits of solution are constrained by the loading weight of the catalyst, which is based on the scale of the reaction (milligram scale, multi-gram scale, multi-kilogram scale CVD).

MATLAB® code of the CVD reactor:

The MATLAB® model developed for the designing of the CVD reactor is presented below:

```
  % Main function
  global rc1 rc2 rcB
  totalflow= 94;
  inertflow=34;
  reactiontime=100/60;
  catalyst_weightloading=0.02;
  rxntem=550;
  CO₂_to_CH₄_ratio=0.6;
  O₂_to_CH₄_ratio=0.1;
  H₂O_to_CH₄_ratio=0.001;
  O₂_to_N2_ratio=0.0645;
  QCH₄_STP=(totalflow−
  inertflow)/(1+CO₂_to_CH₄_ratio+H₂O_to_CH₄_ratio+O₂_to_CH₄_ratio*(1+1/O₂_to_N₂_r
  atio));
  QCO₂_STP=CO₂_to_CH₄_ratio*QCH₄_STP;
  QO₂_STP=O₂_to_CH₄_ratio*QCH₄_STP;
  QN2_STP=inertflow+1/O₂_to_N2_ratio*QO₂_STP;
  QH₂O_STP=H₂O_to_CH₄_ratio*QCH₄_STP;
  tf= QCH₄_STP+QH₂O_STP+QCO₂_STP+QO₂_STP+QN2_STP;
  ICH₄=QCH₄_STP*60*0.716*(1/16.04*1000));
  ICO₂=QCO₂_STP*60*1.977*(1/44.01*1000));
  IN2=inertflow*60*1.25*(1/(28*1000));
  IH₂O=QH₂O_STP*60*0.590*(1/18.016*1000));
  IO₂=QO₂_STP*60*1.43*(1/(32*1000));
  ICO=1E−10;
  IH₂=1E−10;
  IC=1E−10;
  guess=[ICO,IH₂O,ICO₂,IH₂,IN2,ICH₄,IC,IO₂];
  weight=[0.0;catalyst_weightloading/100:catalyst_weightloading];
  global T0
  global Ptot0 C H O tf v_reactor;
  trange=[rxntem,50,rxntem]+273.15;
  l=1;
  for T0=trange(1):trange(2):trange(3)
  m=1;
  for Ptot0=1:1:1
  guess=[ICO,IH₂O,ICO₂,IH₂,IN2,ICH₄,IC,IO₂];
  v_reactor=sum(guess)*8.314*T0/Ptot0/10\hat{ }5;
  [t,para]=ode23s(‘Combined_reforming_Kinetics_basic_od’,weight,guess);
  CO₂_Pcent(l,m)=(guess(3)−para(end,3))*100/guess(3)
  CH₄_Pcent(l,m)=(guess(6)−para(end,6))*100/guess(6)
  H₂O_Pcent(l,m)=(1−guess(2))*100;
  m=m+1;
  end
  l=l+1;
  end
plot(t, para);
legend(‘CO’,‘H₂O’,‘CO₂’,‘H₂’,‘He’,‘CH₄’,‘C’,‘O₂’);
C1=guess(1)*1+guess(2)*0+guess(3)*1+guess(4)*0+guess(5)*0+guess(6)*1+guess(7)*
1;
O1=guess(1)*1+guess(2)*1+guess(3)*2+guess(4)*0+guess(5)*0+gues(6)*0+guess(7)*
0+guess( 8)*2;
H1=guess(1)*0+guess(2)*2+guess(3)*0+guess(4)*2+guess(5)*0+guess(6)*4+guess(7)*
0;
C=para(end,1)*1+para(end,2)*0+para(end,3)*1+para(end,4)*0+para(end,5)*0+para(end
,6)*1+para(end,7)*1;
O=para(end,1)*1+para(end,2)*1+para(end,3)*2+para(end,4)*0+para(end,5)*0+para(end
,6)*0+para(end,7)*0+para(end,8)*2;
H=para(end,1)*0+para(end,2)*2+para(end,3)*0+para(end,4)*2+para(end,5)*0+para(end
,6)*4+para(end,7)*0;
c=C1—C
o=O1—O
h=H1—H
syngasratio=para(end,4)/para(end,1)
carbondeposited=para(end,7)*12
totalcarbonformed=carbondeposited*reactiontime
      %kinetics function
      function dfdw=Combined_reforming_Kinetics_basic_od(I,F)
      global Ptot0 rc1 rc2 rcB
      global T0
      R=8.314;
      Ftot=F(1)+F(2)+F(3)+F(4)+F(5)+F(6)+F(7)+F(8);
      P(1) = Ptot0*F(1)/(Ftot−F(7));
      P(2) = Ptot0*F(2)/(Ftot−F(7));
      P(3) = Ptot0*F(3)/(Ftot−F(7));
      P(4) = Ptot0*F(4)/(Ftot−F(7));
      P(5) = Ptot0*F(5)/(Ftot−F(7));
      P(6) = Ptot0*F(6)/(Ftot−F(7));
      P(7)=0;
      P(8)= Ptot0*F(8)/(Ftot−F(7));
      PCO=P(1);
      PH₂O=P(2);
      PCO₂=P(3);
      PH₂=P(4);
      PHe=P(5);
      PCH₄=P(6);
      PO₂=P(8);
      K1=exp(−11650/T0+13.076);
      K2=exp(1910/T0−1.764);
      K3=exp(−9740/T0+11.312);
      KCH₄=6.65e−4*exp(38280/8.314/T0);
    KCO=8.23e−5*exp(70650/8.314/T0);
    KH₂=6.12e−9*exp(82900/8.314/T0);
    KH₂O=1.77e5*exp(−88680/8.314/T0);
    kin1=4.2258e15*exp(−240100/8.314/T0);
    kin2=1.955e6*exp(−67130/8.314/T0);
    kin3=1.0202e15*exp(−243900/8.314/T0);
    DEN=1+KCH₄*PCH₄+KCO*PCO+KH₂*PH₂+KH₂O*PH₂O/PH₂;
    r_SRM_1=kin1/PH₂\hat{ }2.5/DEN\hat{ }2*(PCH₄*PH₂O—PH₂\hat{ }3*PCO/K1);
    r_SRM_2=kin2/PH₂/DEN\hat{ }2*(PCO*PH₂O—PH₂*PCO₂/K2);
    r_SRM_3=kin3/PH₂\hat{ }3.5/DEN\hat{ }2*(PCH₄*PH₂O\hat{ }2—PH₂\hat{ }4*PCO₂/K3);
    km_c1=5.5619*10\hat{ }4*exp(−65053/R/T0);
    KCH₄_c1=0.1099;
    Km_c1=exp(142.5/R)*exp(−123226/R/T0);
    ko_c2=1.33*10\hat{ }−6*exp(75955/R/T0);
    ko_c2_1=1.67*10\hat{ }9*exp(−148916/R/T0);
    KO_H₂O_c2=1.7372*10\hat{ }4*exp(−60615/R/T0);
    kr_den2=2.51893*10\hat{ }5*exp(−95489/R/T0);
    DEN2=1+KCO*PCO+KCH₄_c1*PCH₄+1/kr_den2*PH₂\hat{ }1.5+1/KO_H₂O_c2*PH₂O/PH₂;
    rc1=km_c1*KCH₄_c1*(PCH₄—PH₂/Km_c1)/DEN2\hat{ }2;
    rc2=(ko_c2*KCO*PCO−ko_c2_1*PH₂O/KO_H₂O_c2/PH₂)/DEN2\hat{ }2;
    k1=1.29*10\hat{ }6*exp(−102065/R/T0);
    KCO₂_1=2.61*10\hat{ }−2*exp(37641/R/T0);
    KCH₄_1=2.60*10\hat{ }−2*exp(40684/R/T0);
    KP1=6.78*10\hat{ }14*exp(−259660/R/T0);
    r_DRM=k1*KCO₂_1*KCH₄_1*PCH₄*PCO₂/(1+KCO₂_1*PCO₂+KCH₄_1*PCH₄)\hat{ }2*(1−
    (PCO*PH₂)\hat{ }2/(KP1*PCH₄*PCO₂));
    Kco_B=exp(−115/R)*exp(92543/R/T0);
    Ko_B=3.0190322*10\hat{ }7*exp(−89805/R/T0);
    k_B=2.673282*10\hat{ }7*exp(−108379/R/T0);
    K_B=exp(−170.44/R)*exp(162483/R/T0);
    DENB=1+(Kco_B*PCO)+(1*PCO₂/Ko_B/Kco_B/PCO);
    rcB=(k_B*Kco_B*(PCO−(PCO₂/K_B/PCO)))/(DENB\hat{ }2);
    k4a= 8.11*10\hat{ }−5*exp(−86000/8.314/T0);
    k4b= 6.82*10\hat{ }−5*exp(−86000/8.314/T0);
    KC_CH₄= 1.26*10\hat{ }−6* exp(−27300/8.314/T0);
    KC_O₂= 7.78*10\hat{ }−12 * exp (−92800/8.314/T0);
    r_com=(1/1000*3600)*(k4a*PCH₄*10\hat{ }5*PO₂*10\hat{ }5/(1+KC_CH₄*PCH₄*10\hat{ }5+KC_O₂*PO₂
    *10\hat{ }5)\hat{ }2 + k4b*PCH₄*10\hat{ }5*PO₂*10\hat{ }5/(1+KC_CH₄*(CH₄*10\hat{ }5+KC_O₂*PO₂*10\hat{ }5));
    experimentalfactor=1;
    r_SRM_1=experimentalfactor*r_SRM_1;
    r_SRM_2=experimentalfactor*r_SRM_2;
    r_SRM_3=experimentalfactor*r_SRM_3;
    r_DRM=experimentalfactor*r_DRM;
    r_com=experimentalfactor*r_com;
    rc1=experimentalfactor*rc1*1;
    rc2=experimentalfactor*rc2*1;
        rCB=experimentalfactor*rcB*1;
        H_SRM_1=224000;
        H_SRM_2=−37300;
        H_SRM_3=187500;
        H_DRM=247000;
        H_c1=74870;
        H_c2=−131325;
        dfdw(1,1)=r_SRM_1−r_SRM_2−rc2+2*r_DRM−2*rCB;
        dfdw(2,1)=−(r_SRM_1+r_SRM_2+2*r_SRM_3)+rc2+2*r_com;
        dfdw(3,1)=r_SRM_2+r_SRM_3−r_DRM+rCB+r_com;
        dfdw(4,1)=3*r_SRM_1+r_SRM_2+4*r_SRM_3+2*rc1−rc2+2*r_DRM;
        dfdw(5,1)=0;
        dfdw(6,1)=−(r_SRM_1+r_SRM_3)−rc1−r_DRM−r_com;
        dfdw(7,1)=rc1+rc2+rCB;
        dfdw(8,1)=−2*r_com;
        end
```

Embodiment example pertaining to the development of the CARGEN® Chemical Vapor deposition (CVD) reactor:

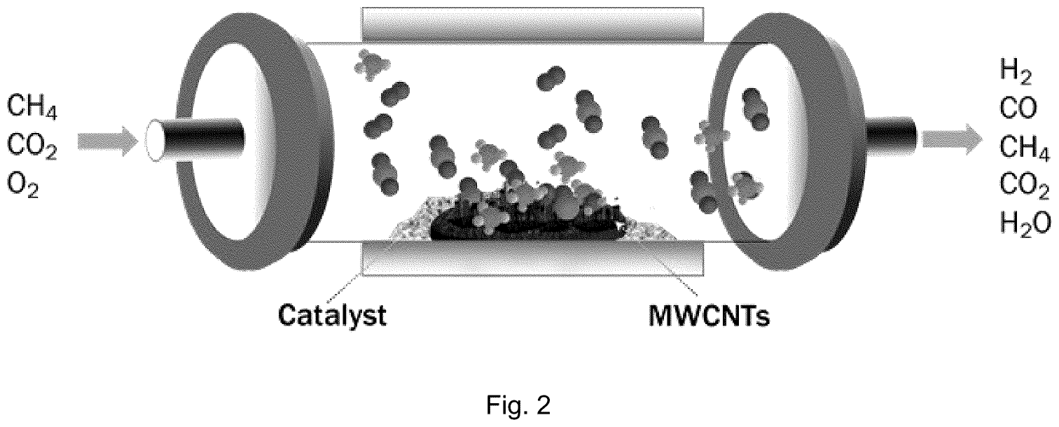

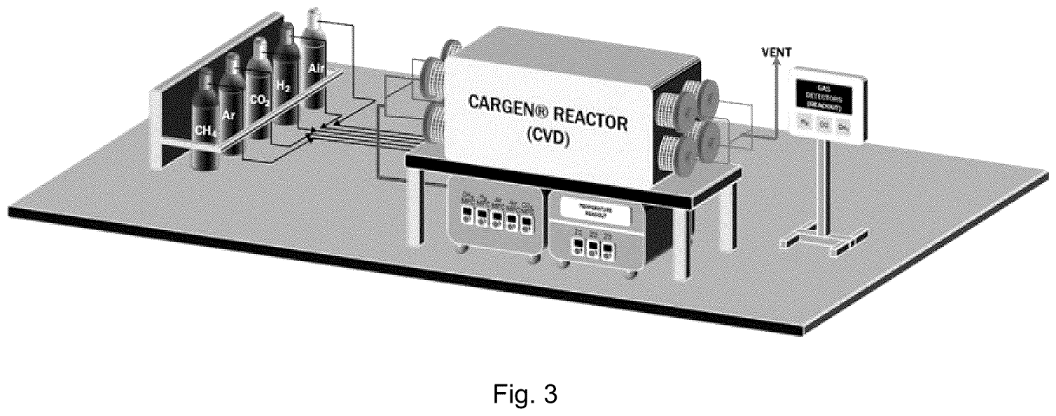

The CARGEN® CVD reactor, designed based on model development studies, incorporates four tubes, each 100 cm long and 15 cm in diameter, as illustrated in FIG. 3 according to an embodiment. A schematic illustration of a single reactor tube of the CARGEN® CVD reactor is illustrated in FIG. 2 and a tabular representation of the non-limiting experimental conditions that were tested is provided below according to an embodiment.

TABLE 3
List of non-limiting operating conditions for the CARGEN ® CVD reactor experiments.

| | | Condition set 1 | | Condition set 2 | | Condition set 3 | |
|---|---|---|---|---|---|---|---|
| | | (milligrams scale) | | (multi-gram scale) | | (multi-kilogram scale) | |
| Catalyst loading | W | 20 | mg | 4 | grams | 100 | grams |
| Initial pressure | Pₜₒₜ₀ | 1 | atm | 1 | atm | 1 | atm |
| Initial | T₀ | 550° | C. | 550° C., 600° C., | | 550° | C. |
| temperature | | | | 750° C. | | | |
| Initial total mass | Qₜₒₜ₀ | 94 | ml/min | 200 | ml/min | 2000 | ml/min |
| flow rate (STP) | | | | | | | |
| Initial mass flow | Q_{CH}_{₄}_{, 0} | 28.8 | mL/min | 96 | mL/min | 616 | ml/min |
| rate of CH₄ | | | | | | | |
| (STP) | | | | | | | |
| Initial mass flow | Q_{CO}_{₂}_{, 0} | 17.2 | mL/min | 57.6 | mL/min | 369 | ml/min |
| rate of CO₂ | | | | | | | |
| (STP) | | | | | | | |
| Initial mass flow | Q_{He, 0} | 30.83 | mL/min | 30.83 | mL/min | 955 | ml/min |
| rate of inert | | | | | | | |
| (STP) | | | | | | | |
| Diameter of tube | D | 2.5 | cm | 5 | cm | 15 | cm |
| Porosity of bed | Ø | 0.6 | | 0.6 | | 0.6 | |
| Bulk density of | ρ_{b} | 1.422 | g/cm³ | 1.422 | g/cm³ | 1.422 | kg/m³ |
| catalyst | | | | | | | |
| Diameter of | Dₚ | 160 | microns | 160 | microns | 160 | microns |
| catalyst particle | | | | | | | |

The developed reactor employs a furnace with a 50 cm heating zone, divided into three equal segments for enhanced temperature control: the inlet zone (0-17 cm), the central zone (17-33 cm), and the outlet zone (33-50 cm). This design leverages insights gained from operating reactors at both multigram and milligram scales, with a strong emphasis on safety considerations. A schematic illustration of the designed CVD reactor is presented below. Whereas a separate embodiment example presents the various safety elements.

To ensure safety, the system includes detectors for flammable and toxic gases linked to an automatic interlock for leak prevention, as well as pressure transducers to monitor any pressure increase across the reactor tubes, activating a safety shutdown if necessary. The reactor also features water-cooled inlet and outlet flanges to keep the surroundings at ambient temperature, with cooling water circulated at a rate of 500 mL/min, entering at 25° C. and exiting around 35° C.

As presented in the safety embodiment example, a thorough Hazard Operability (HAZOP) analysis was carried out in the design and commissioning phases to bolster safety protocols. The reactor's mass flow controllers (MFCs) can deliver up to 8 L/min of reactive and inert gases, while the setup designed for multigram reactions can handle flows up to 600 mL/min. In a standard experiment, 100 grams of a commercial catalyst were used in a single tube. The experimental procedure mirrored that of the multigram demonstrations but extended each phase's duration: drying the catalyst at 150° C. for a day with an argon flow of 2 L/min, catalyst activation at a 10° C./min ramp in 10% H₂/Ar mix, stabilization at 550° C. for two days, followed by a reaction stage using a CH₄/CO₂/O₂/N₂/Ar gas mix (1/0.6/0.1/0.376/1.14) at 550° C. for four days.

### Non-Limiting Results:

The present disclosure utilized a 20% Ni/γ-Al2O3 catalyst for conducting chemical vapor deposition (CVD) experiments on a multi-kilogram scale. This catalyst, which has been previously documented in US20230039945A1, served as a critical component of the experiment. During a singular experiment at this scale, 100 grams of the catalyst were used, with a gas flow rate of 2 L/min. To activate the catalyst effectively and maintain safety, especially when using hydrogen, a gas mixture of 10% H₂/Ar was introduced at a flow rate of 2 L/min, heating the catalyst to 550° C. for two days. Notably, the reduction of nickel oxide to metallic nickel in this catalyst occurs at 525° C. The experiment proceeded for a duration of 96 hours, ultimately producing multi-walled carbon nanotubes (MWCNTs). This synthesis resulted in the collection of approximately 650 grams of material, which included the initial 100 grams of catalyst, netting 550 grams of MWCNTs. The rate of carbon formation observed was around 5.73 g/h.

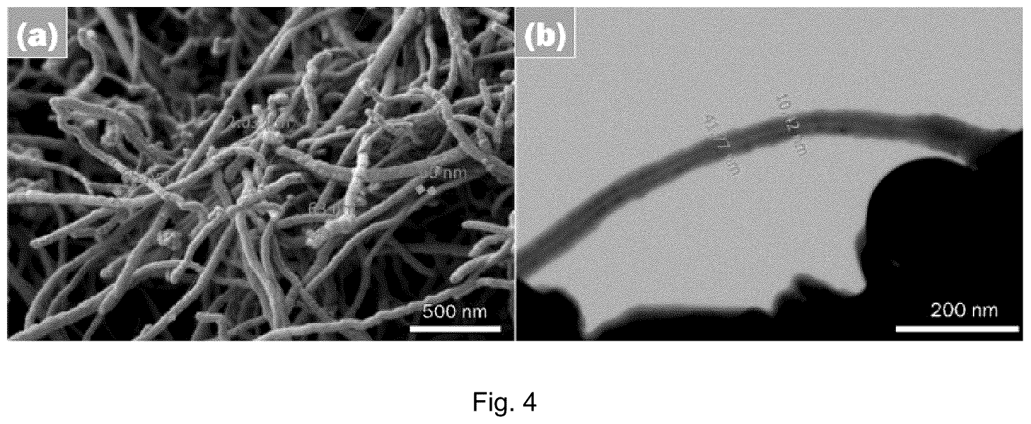

To assess the quality of the MWCNTs generated, three tests were conducted. The first involved acquiring SEM (Scanning Electron Microscopy) and STEM (Scanning Transmission Electron Microscopy) images of the MWCNTs from the multi-kilogram batch to analyze the diameter of the nanotubes. The images, as illustrated in the FIG. 4, show nanotube diameters ranging from 50 to 100 nm. The STEM images particularly highlighted the internal diameter of the MWCNTs, with one tube showing an inner diameter of approximately 10 nm for a nanotube with an external diameter of 41 nm. Given that a single graphene layer measures about 0.34 nm, adjusted to 0.4 nm for calculation purposes, the estimated number of walls in this particular multi-walled nanotube was around 77. However, this count reflects only a single nanotube as observed in the STEM image; other tubes might exhibit variations, with wall counts ranging from 50 to 100.

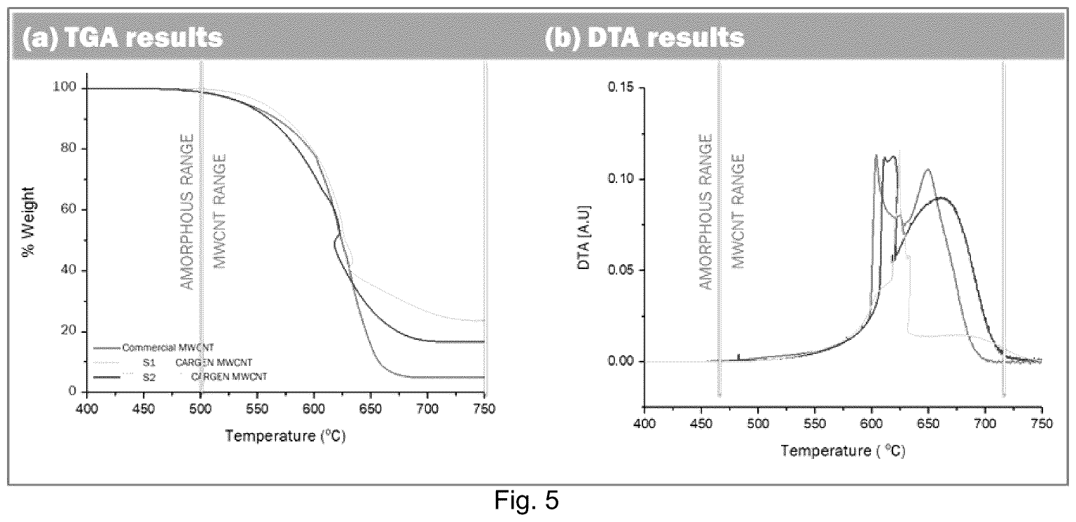

To further analyze and quantify the amounts of amorphous and graphitic carbon in the produced sample, a TGA-DTA (Thermogravimetric Analysis—Differential Thermal Analysis) air combustion study was performed. In this procedure, a sample weighing 10 mg was placed in the TGA apparatus and initially dried under a nitrogen atmosphere at a flow rate of 100 mL/min and a temperature of 150° C. Subsequently, the airflow was switched to 100 mL/min, and the temperature ramp was increased from 150° C. to 400° C. at a rate of 10° C./min, before reducing the rate to 5° C./min to capture detailed combustion profiles. The experiment aimed for a peak temperature of 750° C., followed by a cooling phase back to room temperature under nitrogen gas, maintaining the peak temperature for 30 minutes. The benchmark for this study was established by first testing a commercial MWCNT sample, allowing for comparative analysis with the results from samples produced multiple scales. According to the TGA-DTA results, showcased in FIG. 5, all examined samples exhibited combustion temperatures ranging between 500° C. and 700° C., consistent with expected MWCNT behavior. Notably, the multi-kilogram sample displayed a decomposition temperature close to 500° C., comparable to both the commercial and multi-gram scale samples, suggesting a minimal presence of amorphous carbon.

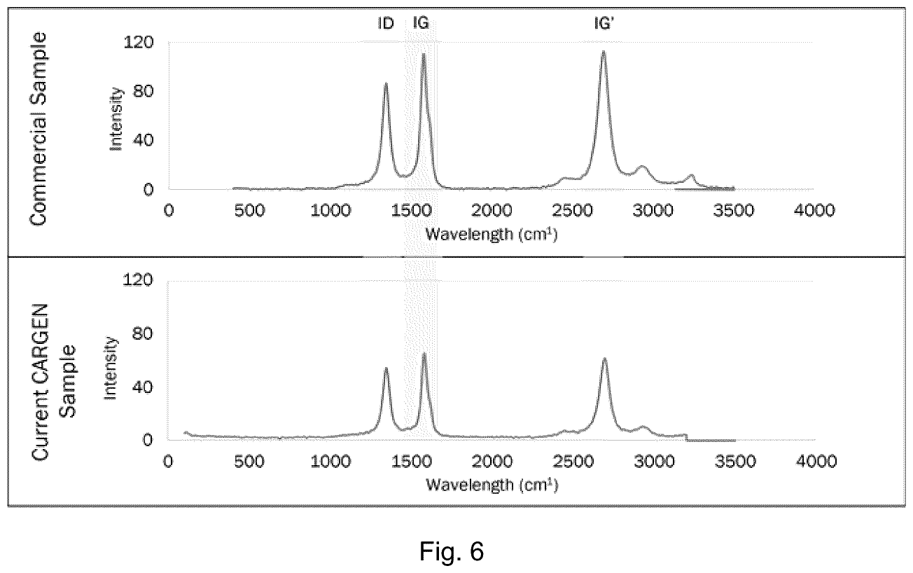

Following the verification of multi-walled carbon nanotubes (MWCNTs), Raman spectroscopy was utilized to qualitatively assess the MWCNTs synthesized in this research compared to those obtained from a commercial supplier. The corresponding Raman spectra are depicted in the FIG. 6. In Raman spectroscopy, the ID/IG ratio serves as a critical metric for evaluating the quality of carbon nanotubes. This ratio compares the intensity of the D band (ID), which signifies defects or disorder within the material, to the intensity of the G band (IG), representing graphitic sp2-bonded carbon structures. The ID/IG ratio thus reflects the extent of disorder or imperfections in carbon-based materials like graphene and carbon nanotubes. Generally, a lower ID/IG ratio implies superior quality of carbon nanotubes, with values below 1 indicating high quality. Another significant measure in Raman spectroscopy is the ID/IG′ ratio, comparing the intensity of the D band (ID) to that of the G′ band (IG′), the latter being a second order scattering of the G band linked to the phonon density states in the material. This ratio is particularly insightful for analyzing structural disorder in graphene, as it is sensitive to the material's layer count and lattice strain. A lower ID/IG′ ratio denotes lesser structural disorder, signifying better quality carbon nanotubes. The ID/IG and ID/IG′ ratios for the three samples are presented in Table 4. Despite the ID/IG and ID/IG′ ratios being below 1, this indicates that the carbon nanotubes under study are of high quality.

TABLE 4
Calculated ID/IG, IG/IG′, and ID/IG′
ratios from the RAMAN results.

| Sample ID | ID/IG | ID/IG′ |
|---|---|---|
| Current Sample | 0.92758 | 0.68970 |
| Commercial sample | 0.83130 | 0.56071 |

### Embodiment Example Showcasing Safety Implementation:

Besides the design of both, CVD and Fluidized bed reactor systems, safety assessments are conducted with detailed HAZOP studies. In this non-limiting embodiment, details are provided regarding the safety systems incorporated for the operation of the reaction system.

### Description of the CVD Reactor System:

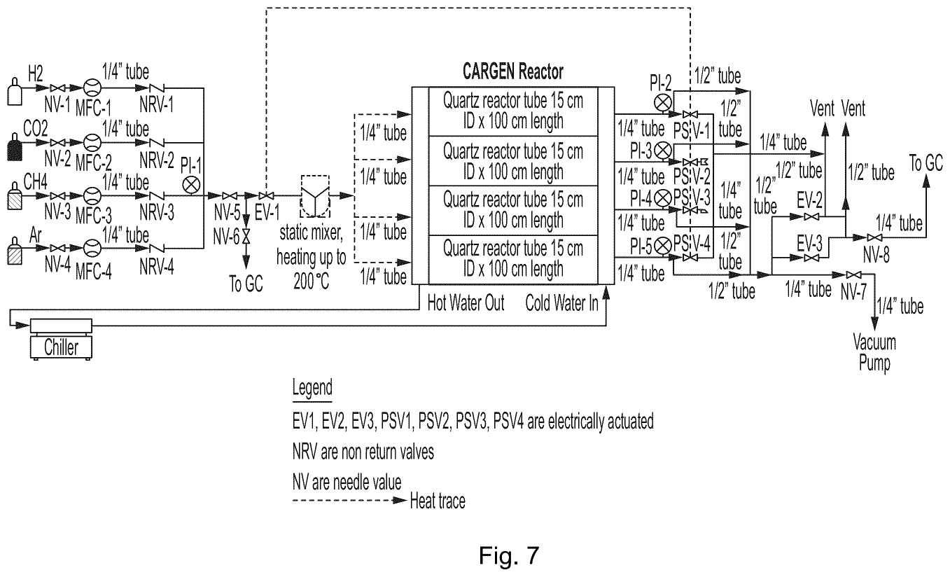

In non-limiting example, the CVD reactor system developed in this process is equipped with four gas inlets corresponding to methane, carbon dioxide, hydrogen, and argon/oxygen/air, each connected to manual needle valves (NV-1 to NV-4), non-return valves (NRV-1 to NRV-4), and mass flow controllers (MFC-1 to MFC-4) as shown in the FIG. 7. Each MFC has a maximum flowrate capacity of approximately 2000 mL/min. The outlets from the NRVs converge into a mixed flow channel tube with a side product draw for GC analysis via a manual needle valve (NV-6). A pressure indicator (PI-1) is installed upstream of the reactor to monitor the pressure of the mixed reaction gases. An electrically actuated valve (EV-1) acts as an interlock, closing if the downstream pressure exceeds 2 atm, as indicated by the pressure safety valves (PSV-1 to PSV-4) at the reactor outlet.

The mixed reactant gas tube from EV-1 can be heated to a higher temperature (up to 200° C.) using an external heating tape arrangement via a coiled static mixer. The reactant gases are then split into four equal outlets, directly connected to the inlets of four reactor tubes housed inside a furnace unit. The furnace unit features a three-zone heating facility, with each zone capable of reaching temperatures up to 1000° C. The quartz reactor tubes have a 15 cm internal diameter, 100 cm length, and 5 mm thickness to withstand pressures up to 15 atm.

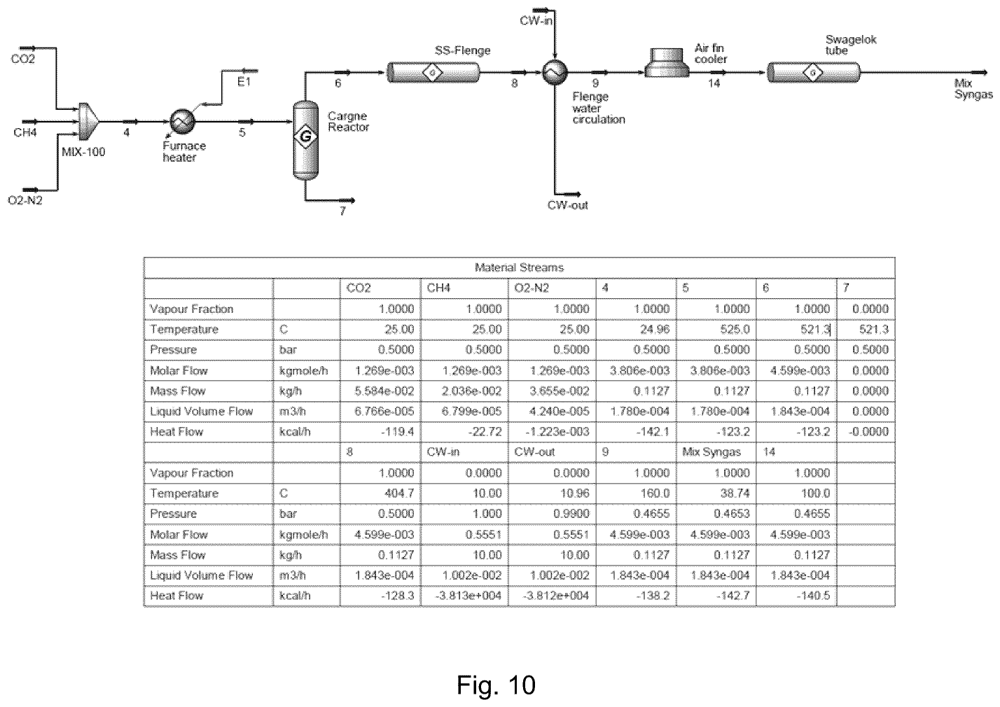

The reactor inlet and outlet flanges are equipped with water cooling provisions to prevent heat radiation and protect the valves and pressure indicators. The purpose of maintaining flange cooling is to prevent the hot tube from expanding and potentially rupturing the flange. Such an occurrence would pose significant dangers, as it could release toxic and flammable gases. Additionally, condensation of steam within the exit gases can lead to pipe blockage and functional issues in valves and fittings. Therefore, ensuring that the exit gases remain at 100° C. mitigates these risks. ASPEN® HYSYS process simulator was employed to size and estimate the cooling water recirculation rate through the chiller (refer to FIG. 10 below). The chiller's inlet and outlet connections are arranged in a counter-flow configuration relative to the reactor unit. Specifically, the cold chiller fluid passes through the reactor's exit flanges, while the hot exit fluid is directed to the reactor's entrance flange before returning to the chiller.

As indicated in the Table in FIG. 10, achieving a temperature reduction from 404° C. to 160° C. at the flanges necessitates cold water at 10° C. with a recirculation rate of 0.01 m³/h. Given that the flange material is stainless steel, properties such as a heat capacity of 490 J/kg·K and a thermal conductivity of 16.2 W/m·K corresponding to stainless steel are utilized. Additionally, a standard room air fan heater is employed to continuously blow air on the exit flange, further reducing its temperature to 100° C.

Four pressure indicators (PI-1 to PI-4) and pressure safety valves (PSV-1 to PSV-4) are installed on the exit lines of each reactor tube, with PSVs designed for a pressure of 1 bar each. All four lines are interconnected at the exit and entrance of the reactor to provide redundancy in PSVs.

The product lines from the PSVs are connected to a common duct, split three ways: one directed towards venting (via EV-2), one towards GC analysis (via EV-3 and NV-8), and one to a vacuum pump (via NV-7). In case gases need to be fed to the GC, NV-8 must be opened, and EV-3 actuated. The programming ensures that when EV-3 is open, EV-2 closes automatically, and vice versa. If NV-8 is inadvertently closed, the intermediate vent line safely removes reaction gases to prevent accumulation or build-up in the tubes. In the event of PSV activation, the common collection duct allows for direct venting of gases connected to the exhaust, and inlet gas flow is automatically halted due to interlock activation.

### Critical Safety Considerations:

Ventilation: Ventilation plays a critical role in ensuring the safe removal of vented gases and dissipating any gases released during accidental events. Given that the CARGEN® reaction involves a highly flammable feed, all reactions were conducted within a fume hood. This specialized enclosure provides a controlled environment, effectively containing any potential hazards. Moreover, the release of post-reaction gases directly into the exhaust system of the fume hood, which operates at a rate of 6-12 air cycles per hour, further enhances safety measures. This system is designed to handle both flammable and toxic gases, thus minimizing any risks associated with gas release. Following is the calculation of Air Changes Per Hour (ACPH):

ACPH=(60 Q)/Vol. Where, Q=Volumetric flow rate of air and Vol=Space volume.

The fume hood has dimensions of 1.5 m (length) by 0.8 m (width) by 1.5 m (height), resulting in a volume of 1.8 m³. The volumetric flow rate of gas (Q) that the fume hood can handle is approximately 0.18 m/h (180 L/h). During a typical CARGEN® experiment, the maximum gas flow rate will not exceed 120 L/h, considering the maximum flow capacity of the mass flow controller (MFC). This means that the maximum gas accumulation in the fume hood will be approximately 120 L/h. Consequently, the fume hood is designed to safely handle gas accumulation typical of the effluent from the CARGEN® reactor, ensuring safe operation within the hood.

Flammability limits of CARGEN® gas: An essential safety consideration is understanding the flammability limits of gases and gas mixtures before conducting any experiments. Specifically, the Lower Flammability Limit (LFL) refers to the lowest concentration (percentage) of a gas or vapor in air capable of producing a flash of fire in the presence of an ignition source (such as an arc, flame, or heat). Many safety professionals consider this term to be synonymous with the Lower Explosive Limit (LEL).

The LEL of mixtures comprising several combustible gases can be calculated using Le Chatelier's mixing rule for combustible volume fractions (Xi), as given in equation below.

$${LEL}_{m} = \frac{100}{{\sum }_{i}^{n} \frac{{X}_{i}}{{LEL}_{i}}} ,$$

where, LELᵢ is the lower flammability limit of the flammable gas.

The feed gas composition used in the CARGEN® reaction and its LEL value is given in the Table 5 below:

TABLE 5
Feed gas composition and flammability limits:

| Gas type | Mole fraction (Xi) | Vol % |
|---|---|---|
| CO₂ | 0.23 | 23 |
| CH₄ | 0.38 | 38 |
| N₂ | 0.34 | 34 |
| O₂ | 0.05 | 5 |

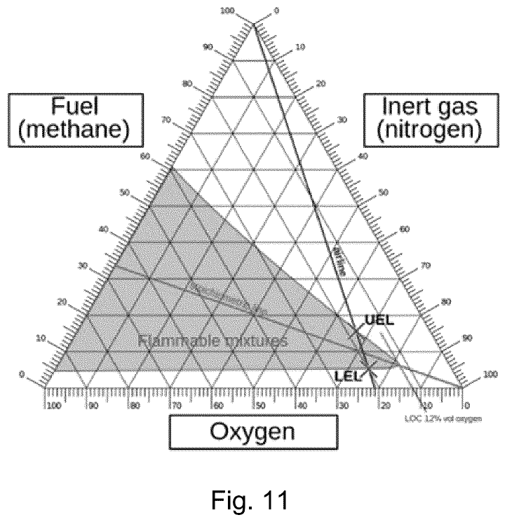

The gas mixture used as feed contains the flammable gasses methane (CH₄) and oxygen (O₂), which presents a potential risk of forming an explosive mixture within the reactor if not adequately mixed. The graphical representation of the actual flammability envelope, delineating the range of flammable mixtures of methane, is provided in FIG. 11.

The triangular region highlighted in orange on the ternary plot shown in FIG. 11 delineates the flammable composition for gas mixtures containing methane, oxygen, and inert components. Gas compositions falling below the Lower Explosive Limit (LEL) within this triangle are too lean to be flammable or explosive, while those above it are too rich for such reactions. It is crucial to conduct operations with gas compositions that avoid overlapping with the orange area depicted in FIG. 11 to mitigate the risk of flammability and explosion.

To ensure safe operation of the process, several safety scenarios have been devised. These scenarios are aimed at identifying potential hazards and mitigating risks associated with the experimental procedures. One critical aspect involves understanding the flammability limits of the gas mixtures used, particularly those containing methane and oxygen, to prevent the formation of explosive mixtures within the reactor. A graphical representation of the flammability envelope in FIG. 11 serves as a reference to avoid gas compositions that overlap with the orange-colored region, indicating flammable compositions. Furthermore, ventilation systems and fume hoods are utilized to safely handle any gas emissions, with strict adherence to maximum flow rates to prevent accumulation of hazardous gases. These safety measures are integral to ensuring the protection of personnel and equipment during experimental operations.

### Safety Scenarios:

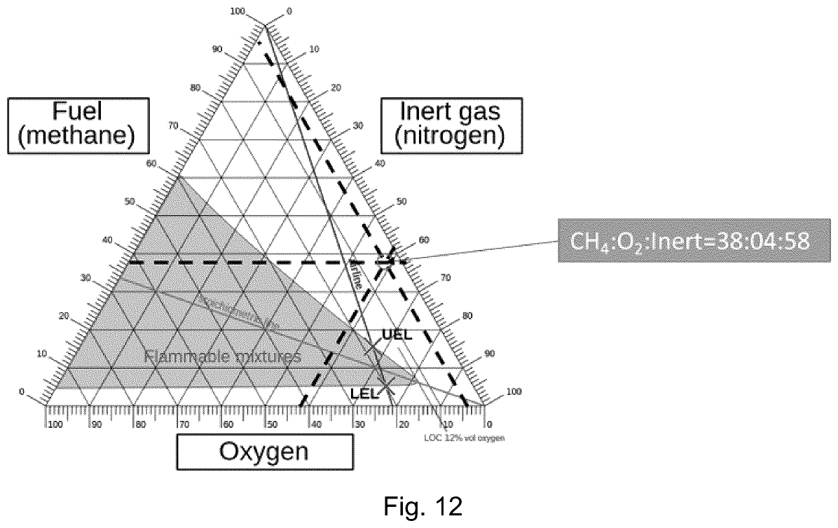

During start-ups: When plotting the CARGEN® feed gas on the ternary plot (FIG. 12), the typical gas mixture is notably situated well above the Upper Explosive Limit (UEL), as indicated by the red circle. Consequently, this mixture is too rich to be flammable and explosive. To align with the designated safe operation window for gas mixtures, a gas composition comprising 10% CH₄ and 90% N₂ is utilized in MFC-3, while pure CO₂ is employed in MFC-1 and pure CH₄ in MFC-2. It is strictly prohibited to use pure O₂ in MFC-3 within the current reactor configuration, emphasizing the importance of adhering to safety protocols.

Faulty operation of Oxygen MFC-3 being 100% open: If MFC-3 experiences a failure to maintain the desired flow rate, whether due to incorrect inputs or faulty calibration, the resulting gas mixture may deviate from the intended composition, potentially posing a risk of explosion. However, introducing a 10% Oxygen cylinder and operating MFC-3 at 100% open would not yield an explosive mixture. In essence, the condition of MFC-3 being fully open would mirror the desired operational state, mitigating the risk associated with deviations in gas flow rates.

Deviations-Lesser flow rates: In case of lesser flow of oxygen than the desired flow, the scenario will not even result in an explosive mixture and only effect a faulty experiment due to insufficient oxygen concentration per the stoichiometric requirement of the reaction.

Deviations-higher flow rates: Faulty operation of Oxygen MFC-3 being fully open: The scenario of MFC-3 being fully open differs significantly from the case of it being 100% open. In the 100% open scenario, an electrical signal still regulates the valve opening of MFC-3, ensuring that only the designed capacity of the MFC-3 (which is 2000 mL/min) is allowed to flow. However, in a fully open scenario, it is assumed that electrical control is lost, and the quarter-inch internal diameter tube of MFC-3 is wide open, enabling gas to flow from the 3-atm upstream pressure to atmospheric pressure in the reactor. Under this circumstance, approximately 379,860 mL/min of 10% O₂ will be delivered into the reactor, as calculated using equation (Eq. 3) below.

$$Q = 5.4741 {0}^{- 4} F \frac{Ts}{Ps} \sqrt{\frac{( {P}_{1}^{2} - {P}_{2}^{2} )}{{γ}_{g} {T}_{f} {L}_{e}}} \times {D}^{2.5}$$

Where, Q is the volumetric flow rate in SCMD, F is the transmission factor (dimension less), Tₛ is standard temperature (K), Pₛ is standard pressure (kPa), P₁ is the upstream pressure (kPa) and P₂ is downstream pressure (kPa), T_{f} is average gas flow temperature (K), Lₑ is equivalent length of pipe (km), Z is gas compressibility factor (dimensionless), D is the pipe inside diameter (mm), γ_{g} is gas gravity.

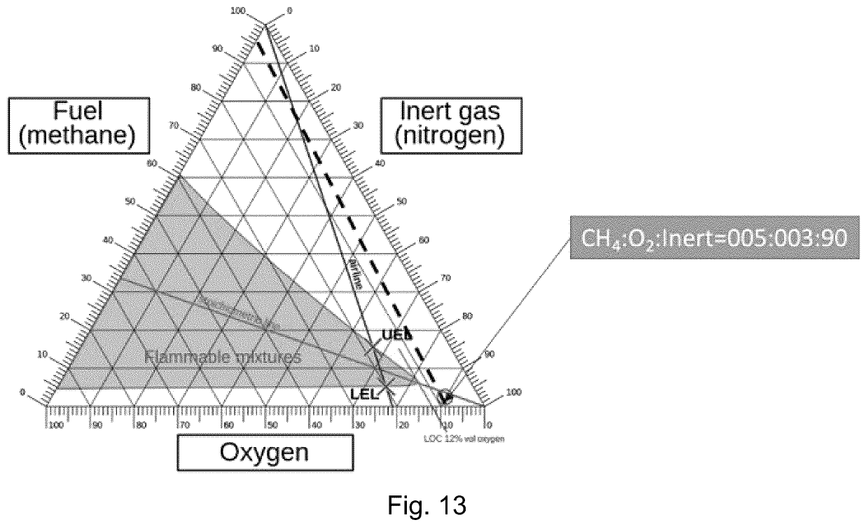

Therefore, reactor will be saturated with the inert gas and the resulting mixture will fall below the LEL level as depicted in the FIG. 13.

Therefore, extremely higher flow rate of gas from the MFC-3 even does not lead to a safety event as the resulting mixture is too lean to be either flammable or explosive.

Deviations—MFC-3 being fully closed: This scenario closely resembles the conditions of a dry reforming of methane reaction, which is known to be very rich and thus not flammable or explosive. Consequently, it does not pose any safety risk or potential for safety events.

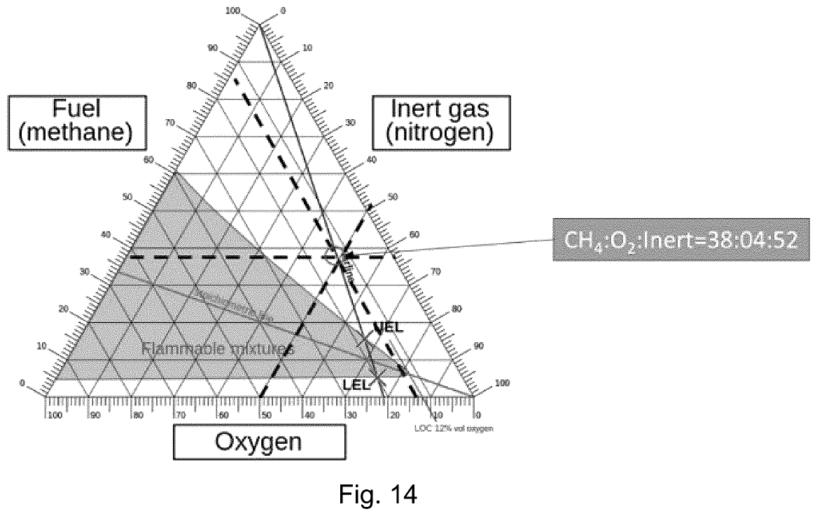

Gas leak in the reactor tube: A gas leak in the reactor tube, particularly due to failure to seal it properly, poses significant safety concerns. If air seeps into the reactor, it can alter the reaction mixture, potentially leading to safety events that need to be thoroughly evaluated. In the event of an air leak, where reaction gases mix with air containing 20% O₂, the resulting gas mixture will exceed the Upper Explosive Limit (UEL), as depicted in FIG. 14. This indicates the potential for flammability and explosive hazards, underscoring the critical importance of maintaining proper seals and preventing air ingress into the reactor system.

While the gas composition used in operations is relatively safer, there remains a risk of methane leaks within the laboratory environment, which is undesirable. In a closed laboratory setting, the concentration of methane can potentially increase, posing a risk of asphyxiation if the methane concentration exceeds 500,000 parts per million (ppm). To mitigate such situations, a gas alarm equipped with a methane gas detector is connected to the reactor. This alarm system is programmed to trigger a High (Hi) alarm at 5% of the Lower Explosive Limit (LEL) and a Hi-Hi alarm, shutting down the entire operation, at 10% of the LEL. Additionally, the laboratory ventilation system, represented by ACPH-6, operates continuously to circulate fresh air, thereby preventing the accumulation of methane within the laboratory space. These safety measures are implemented to ensure the well-being of personnel and maintain a safe working environment.

### During Reaction:

Desired operation: During normal operation of the CARGEN® reactor, both carbon monoxide (CO) and hydrogen (H₂) are produced as gaseous by-products alongside multi-walled carbon nanotubes (MWCNTs). Hydrogen presents a significant safety risk due to its very low Lower Explosive Limit (LEL) of 4% in air. Additionally, the operating temperature of the CARGEN® reaction, approximately 550° C., is close to the autoignition temperature of hydrogen, which is 585° C. Therefore, it is crucially important to ensure that the reaction chamber or reactor remains free from oxygen gas to prevent the formation of an explosive mixture, which could result in damage to the facility.

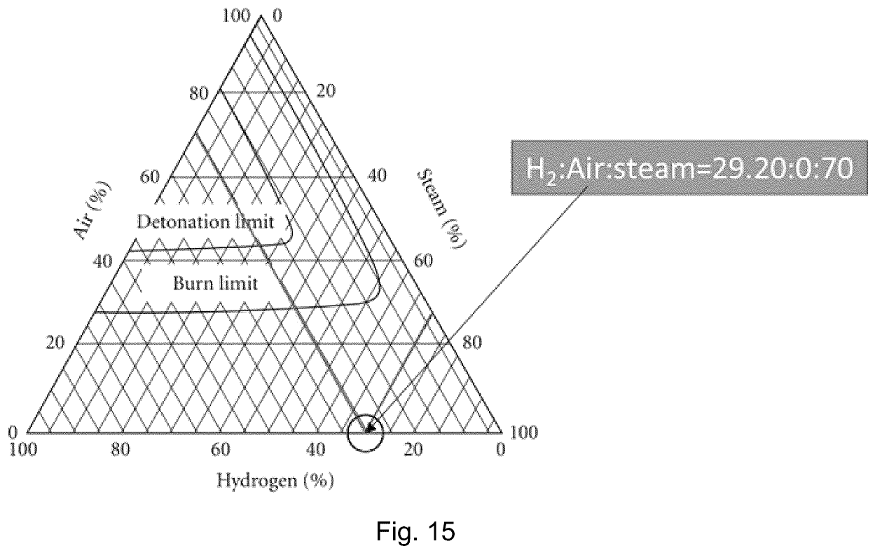

The unique configuration of the CARGEN® reactor ensures that all oxygen is consumed during operation, thereby rendering the reaction mixture free from oxygen. Consequently, the resulting gas mixture within the reaction chamber, arising from evolved gases and unreacted reaction mixture, has a composition of H₂:Air:Inert=30:0:70. The ternary plot provided in FIG. 15 illustrates the explosion limits and detonation limits of hydrogen gas in the presence of steam and air. Under no circumstances should the reactor be operated within the detonation limits zone or the flammability zone (burn limit) to avoid potential catastrophes.

In a desired operation, the mixture of evolved gases from the CARGEN® reaction falls significantly below the detonation and flammability limits of hydrogen gas, as depicted in FIG. 15. Consequently, the operation is considered safe to proceed.

Faulty operation of Oxygen MFC-3 being 100% open: In the event of a malfunction or 100% open condition of the mass flow controller (MFC), resulting in an unintended gas flow rate, the gas mixture within the reactor tube will remain consistent with the desired condition. This is attributed to the use of a 10% oxygen gas source, which ensures that the composition of the gas mixture remains unchanged. As a result, the operation is considered to be safer and does not introduce any new risks.

Deviations-Lesser flow rates: In case of lesser flow of oxygen than the desired flow, the scenario will not even result in an explosive mixture and only effect a faulty experiment due to insufficient oxygen concentration per the stoichiometric requirement of the reaction.

Deviations-higher flow rates: Faulty operation of Oxygen MFC-3 being fully open: In the fully open scenario of MFC-3, a significant distinction arises from the 100% open case. While in the 100% open case, an electrical signal regulates the valve opening of MFC-3, allowing only the design capacity of 2000 mL/min to flow, the fully open scenario assumes a loss of electrical control. In this scenario, the quarter-inch internal diameter tube of MFC-3 remains wide open, enabling gas flow from the 3-bar upstream pressure to atmospheric pressure within the reactor. Consequently, approximately 379,860 mL/min of 10% O₂ will flow into the reactor, as calculated using the equation.

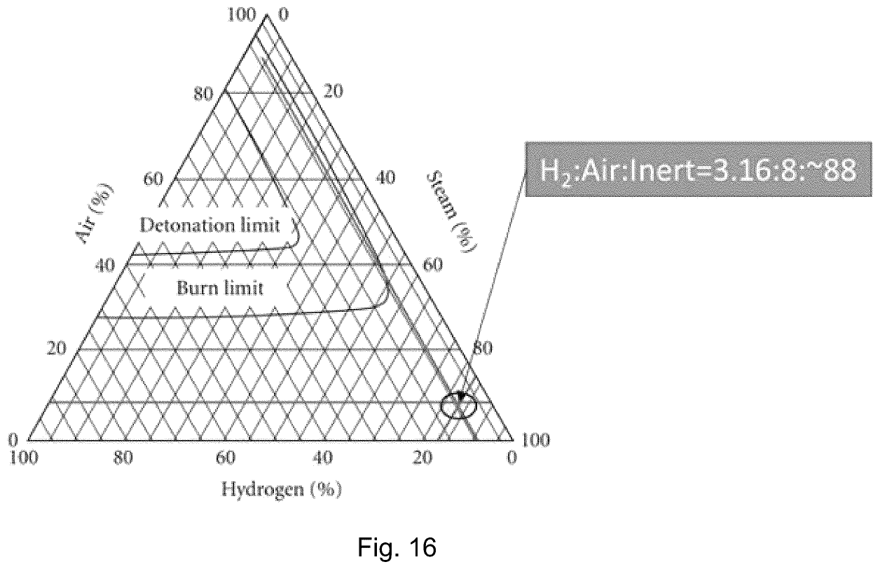

Under these conditions, the reactor becomes saturated with inert gas, resulting in a mixture that falls below both the detonation level and the Lower Explosive Limit (LEL) of H₂ gas, as illustrated in FIG. 16. This configuration ensures that the operation remains within safe parameters, mitigating the risk of potential explosions or flammability hazards.

Despite the exceptionally high gas flow rate from MFC-3 in the fully open scenario, a safety event is averted due to the resulting gas mixture being too lean to pose any flammability or explosion risks. This outcome is attributed to the saturation of the reactor with inert gas, a result of the loss of electrical control over MFC-3. In this scenario, where the quarter-inch internal diameter tube of MFC-3 is unrestricted, gas flows from the 3-atm upstream pressure to atmospheric pressure within the reactor, leading to a flow rate of approximately 379,860 mL/min of 10% O₂. This influx of inert gas ensures that the resulting mixture falls below both the detonation level and the Lower Explosive Limit (LEL) of H₂ gas, as depicted in FIG. 16. Consequently, the operation proceeds safely, without the risk of flammability or explosive events.

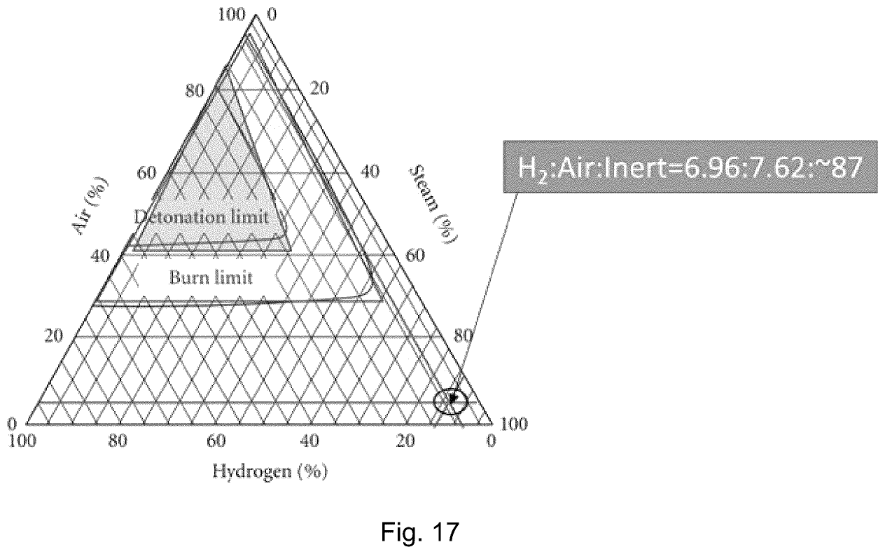

Leak in the reactor tube: If the reactor fails to be properly sealed, there is a risk of air seeping in and altering the reaction mixture, potentially leading to safety events that must be assessed. In the event of an air leak, where reaction gases mix with air containing 20% O₂, the resulting gas mixture will fall below both the Lower Explosive Limit (LEL) and the detonation level of the H₂ mixture, as illustrated in FIG. 17. This configuration ensures that the operation remains within safe parameters, mitigating the risk of potential explosions or flammability hazards despite the presence of air in the reactor tubes.

Despite the relatively safer gas composition used in operations, the laboratory environment remains vulnerable to the risks of methane, hydrogen, and CO leaks, each presenting distinct hazards. Unwanted gas leaks in the lab are highly undesirable, with the potential for grave consequences. Within a closed lab environment, the accumulation of methane can escalate, posing a severe risk of asphyxiation if concentrations exceed 500,000 parts per million (ppm). To prevent such extreme scenarios, a comprehensive gas detection system is employed, comprising methane, hydrogen, and CO gas detectors, all interconnected with the reactor. These detectors are configured to trigger a High (Hi) alarm at 5% of the Lower Explosive Limit (LEL), with a Hi-Hi alarm activating to shut down the entire operation at 10% of the LEL. Notably, CO stands out as one of the most toxic gases, posing an immediate threat to researchers in the event of a leak before the gas alarm can activate and halt the reaction. Therefore, it is imperative that the gas alarm be meticulously calibrated to adhere to the standard limits set by regulatory bodies like the Occupational Safety and Health Administration (OSHA), ensuring the timely detection and mitigation of any hazardous gas leaks within the laboratory.

Below is a summary of different exposure limits of CO gas:
NIOSH REL: 35 ppm (40 mg/m3) TWA, 200 ppm (229 mg/m3) CEILING
Current OSHA PEL: 50 ppm (55 mg/m3) TWA
1989 OSHA PEL: 35 ppm (40 mg/m3) TWA, 200 ppm (229 mg/m3) CEILING
1993-1994 ACGIH TLV: 25 ppm (29 mg/m3) TWA
Description of Substance: Colorless, odorless gas.
LEL: 12.5% (10% LEL, 12,500 ppm)
Original (SCP) IDLH: 1,500 ppm

Existing short-term exposure guidelines: National Research Council Emergency Exposure Guidance Levels (EEGLs):
10-minute EEGL: 1,500 ppm
30-minute EEGL: 800 ppm
60-minute EEGL: 400 ppm
24-hour EEGL: 50 ppm

The gas detectors are calibrated with the following detection level in line with OSHA limits as given in the below Table 6:

TABLE 6
Gas alarm set values for leak detection.

| | Hi | Hi-Hi | |
|---|---|---|---|
| Gas | (PPM) | (PPM) | Note |
| CO | 30 | 50 | OSHA long term exposer limit is 8 h |
| H₂ | 2000 | 4000 | Maximum allowable limit as per U.S. |
| | | | Environmental Protection Agency is 10% of |
| | | | LEL of H₂; the LEL of H₂ is 4% |
| CH₄ | 2500 | 5000 | Maximum allowable limit as per U.S. |
| | | | Environmental Protection Agency is 10% of |
| | | | LEL of CH₄; the LEL of CH₄ is 5% |

The development and operation of both the multi-gram and kilogram-scale reactors either CVD or fluidized bed, mark significant milestones in the quest for sustainable and innovative chemical processes. These reactors not only facilitate the synthesis of valuable carbon materials but also underscore a commitment to safety and responsible research practices. Throughout the discussion, safety considerations have remained paramount. From meticulously engineered gas detection systems to stringent protocols for gas composition and reactor sealing, every aspect of operation prioritizes the well-being of researchers and the integrity of the laboratory environment.

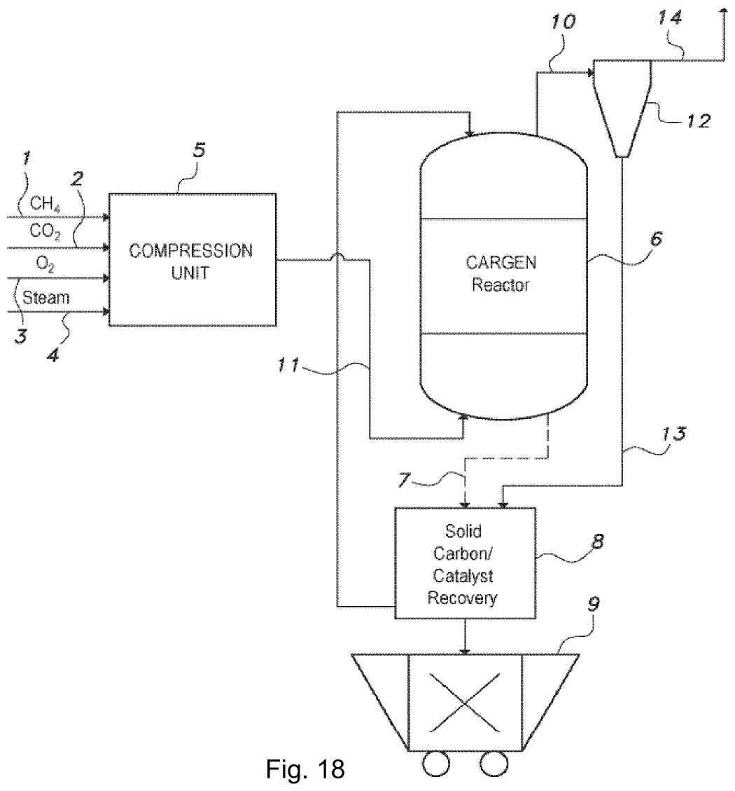

FIG. 18 shows a conceptual process flow diagram to depict the operation of the carbon generator (CARGEN®) reactor or the first reactor in the two-reactor system of the present disclosure according to an embodiment. Compression unit 5 receives methane 1, carbon dioxide 2, oxygen 3, and steam 4 inputs. Compression unit 5 provides an output 11 of compressed feed gas mix to the CARGEN® reactor 6. The CARGEN® reactor 6 outputs the unreacted gases 10, which goes to a cyclone or electrostatic precipitator 12, which produces unreacted methane, carbon dioxide, and steam 14, and recovered solid carbon 13. A solid carbon/catalyst recovery unit 8 receives inputs of the spent catalyst and solid carbon 7 from the CARGEN® reactor 6 and the recovered solid carbon 13 from the cyclone or electrostatic precipitator 12. The catalyst recovered is regenerated and fed back to the CARGEN® reactor 6, and the carbon is discarded to the discarded carbon and catalyst collector 9.

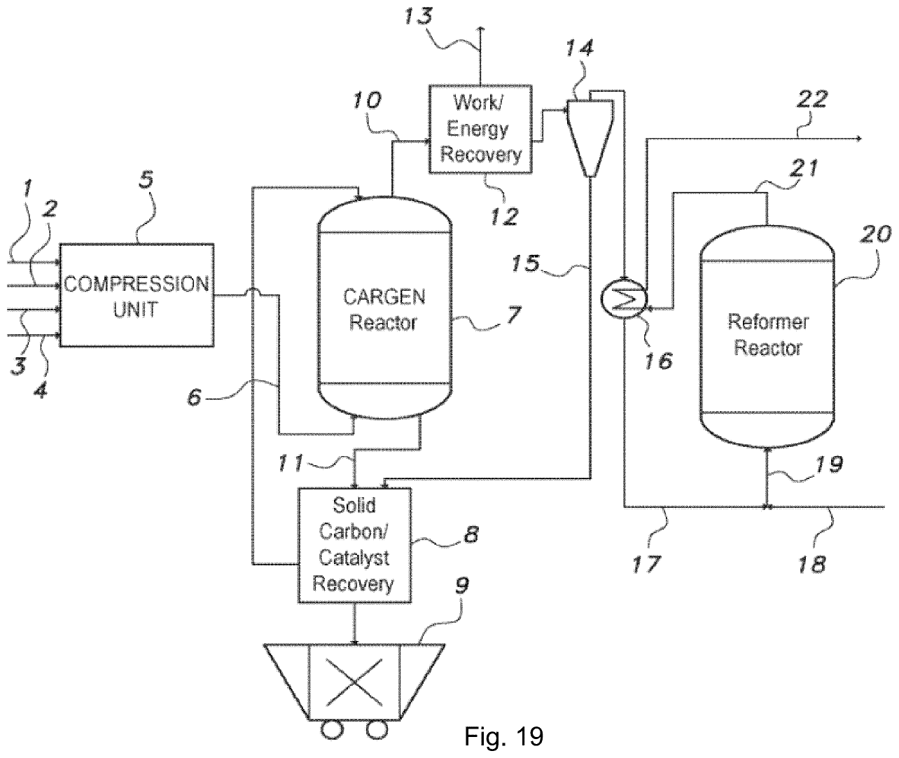

FIG. 19 is a non-limiting example of the two-reactor system according to the present subject matter. FIG. 19 shows a compression unit 5 receiving inputs of methane 1, carbon dioxide 2, oxygen 3, and steam 4. Compression unit 5 provides output 6 of compressed feed gas mix to the CARGEN® reactor 7. According to an embodiment, a work/energy recovery unit 12 can be provided. The CARGEN® reactor 7 can provide an output 10 of unreacted gases from the CARGEN® reactor at a high pressure to the work/energy recovery unit 12.

The work/energy recovery unit 12 can then output extracted work/energy 13 and provide feed to the cyclone/electrostatic precipitator 14. The cyclone/electrostatic precipitator 14 provides outputs of recovered solid carbon 15 to the solid carbon/catalyst recovery unit 8. The solid carbon/catalyst recovery unit 8 regenerates the catalyst (removes carbon from the catalyst) and provides the catalyst back to the CARGEN® reactor 7. Any carbon and/or catalyst to be discarded is directed to the discarded carbon/catalyst collector 9. The cyclone/electrostatic precipitator 14 also outputs unreacted methane, carbon dioxide, and/or steam to a heat exchanger unit 16. From the heat exchanger unit 16, high temperature and low-pressure gases 17 are directed to the reformer reactor or second reactor 20. An additional feed of methane, oxygen, and steam 18 combine with the high temperature and low-pressure gases from the heat exchanger unit 17 to serve as feed gases 19 to the reformer reactor 20. The reformer reactor 20 then outputs high temperature syngas 21 to the heat exchanger unit 16. The heat exchanger unit 16 outputs low temperature syngas 22.

In an embodiment, the first reactor (6, 7), such as, of the CARGEN® system and process, is generally shown in FIGS. 18 and 19. The first reactor, in an embodiment, includes a fluidized bed reactor including a vertical reactor tube configured for allowing conducting fluidization of a catalyst using a reaction gas including, for example, a greenhouse gas to form a carbon material. The greenhouse gas, for example, includes one or more of a volatile organic compound (e.g., methane), a hydrocarbon, carbon dioxide gas, oxygen gas, air, nitrogen, carbon monoxide, hydrogen and the like. The catalyst includes, for example, a CARGEN® catalyst disclosed in, for example, WO2021125990 which is incorporated herein by reference.

In another embodiment, the first reactor (6, 7), such as, of the CARGEN® system and process, as generally shown in FIGS. 18 and 19 includes a chemical vapor deposition reactor including a horizontal reactor tube configured to facilitate reaction of a catalyst (e.g., CARGEN® catalyst) due to the flow of a reaction gas (e.g., greenhouse gas) through the reactor.

The reactor configuration of the present disclosure is highly scalable and can be implemented on demonstration and commercial scale to produce bulk quantities of a carbon material (e.g., carbon nanotubes) by the reaction of a greenhouse gas, such as, via the CARGEN® system and process. For example, the reactor configuration can be scaled up to tons of carbon material production (e.g., carbon nanotubes), which is a material of high economic value and demand. The fluidized bed reactor and the chemical vapor deposition reactor utilized in reactor configuration, system and method for producing carbon material and syngas, such as, in relation to the CARGEN® system and process, will be described below in further detail according to an embodiment.

In addition, both the reactor systems (e.g., the fluidized bed reactor and the chemical vapor deposition reactor) may also be configured with, for example, a flammable and toxic gas detection system that can trigger safety interlock in the event of gas leaks enabling the system to be operated unattended and continuously for long time on stream. Both the reactor configurations may also have a provision to be connected to analytical setups like Gas Chromatography equipment, Residual Gas Analyzers, etc. for real time monitoring of reaction progress and conversions. The reactor can be operated in both negative pressure (e.g., −1 bar) and in positive pressure (e.g., 0-20 bar). The reactor system may also have a tunable recycle stream and a purge stream to adjust the overall conversion of the feed gas and carbon formation rate.

The reactor configuration, such as, for CARGEN® technology, is suitable to operate at multiple levels of scalability, such as, milligrams, multigrams, kilograms and scaled-up to tons of carbon material production. Further, the reactor configuration is suitable for repeated operation to ensure reproducibility of data and the material produced during the reaction.

The present disclosure also includes one or more additional features that are auxiliary to the reactor configuration, such as, for CARGEN® technology. The additional features include, for example, heaters, coolers, chillers, the mechanism to load and unload solid materials in the reactor, gas/solid separators, the furnace, the flow devices, the pressure devices, the electronics, and the like.

As used herein and in the appended claims, the singular form of a word includes the plural, unless the context clearly dictates otherwise. Thus, the references “a,” “an” and “the” ingredient” or “a method” includes a plurality of such “ingredients” or “methods.” The term “and/or” used in the context of “X and/or Y” should be interpreted as “X,” or “Y,” or “X and Y.”

Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” is also a disclosure of embodiments “consisting essentially of’ and “consisting of’ the disclosed components. Where used herein, the term “example,” particularly when followed by a listing of terms, is merely exemplary and illustrative, and should not be deemed to be exclusive or comprehensive. Any embodiment disclosed herein can be combined with any other embodiment disclosed herein unless explicitly indicated otherwise.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A reactor system for producing a carbon material and a syngas, comprising:
a reactor configured for receiving a gas feed including a greenhouse gas and producing a carbon material and a reactor gas feed, wherein the reactor comprises a fluidized bed reactor including a vertical reactor tube configured for conducting fluidization of a catalyst using the gas feed to form the carbon material and the reactor gas feed, and wherein the reactor gas feed is utilized to produce the syngas.

2. The reactor system of claim 1, wherein the reactor includes a plurality of heating zones.

3. The reactor system of claim 2, wherein the heating zones of the reactor are capable of heating up to 1000° C.

4. The reactor system of claim 1, wherein the reactor includes a catalyst bed provided on one or more perforated plates that allow for a suitable flow of the gas feed.

5. The reactor system of claim 1, wherein the catalyst includes a CARGEN® catalyst.

6. The reactor system of claim 1, wherein the greenhouse gas includes one or more of a volatile organic compound, a hydrocarbon, carbon dioxide gas, oxygen gas, air, nitrogen, carbon monoxide, and hydrogen.

7. The reactor system of claim 1, wherein the vertical reactor tube is composed of steel, a metal alloy, or a protective internal coated metal tube.

8. The reactor system of claim 1, wherein the carbon material includes carbon nanotubes.

9. The reactor system of claim 1, wherein the reactor is scalable for production of up to tons the carbon material.

10. The reactor system of claim 1, further comprising a second reactor configured to receive a second reactor feed gas including the reactor feed gas and to produce the syngas.

11. A reactor system for producing a carbon material and a syngas, comprising:
a reactor configured for receiving a gas feed including a greenhouse gas and producing the carbon material and a reactor gas feed, wherein the reactor comprises a chemical vapor deposition reactor including a horizontal reactor tube configured to facilitate reaction of a catalyst due to flow of the gas feed through the reactor to form the carbon material and the reactor gas feed, and wherein the reactor gas feed is utilized to produce the syngas.

12. The reactor system of claim 11, wherein the horizontal reactor tube is composed of quartz, steel, a metal alloy, or a protective internal coated metal tube.

13. The reactor system of claim 11, wherein the greenhouse gas includes one or more of a volatile organic compound, a hydrocarbon, carbon dioxide gas, oxygen gas, air, nitrogen, carbon monoxide, and hydrogen.

14. The reactor system of claim of claim 11, wherein the catalyst includes a CARGEN® catalyst.

15. The reactor system of claim of claim 11, wherein the reactor is scalable for production up to tons the carbon material.

16. The reactor system of claim of claim 15, wherein the carbon material includes carbon nanotubes.

17. The reactor system of claim 1, further comprising a second reactor configured to receive a second reactor feed gas including the reactor feed gas and to produce the syngas.

18. A method for producing a carbon material and a syngas, the method comprising utilizing a reactor configured for receiving a gas feed including a greenhouse gas and producing a carbon material and a reactor gas feed, wherein the reactor comprises a fluidized bed reactor including a vertical reactor tube configured for conducting fluidization of a catalyst using the gas feed to form the carbon material and the reactor gas feed, and wherein the reactor gas feed is utilized to produce the syngas.

19. A method for producing a carbon material and a syngas, the method comprising utilizing a reactor configured for receiving a gas feed including a greenhouse gas and producing the carbon material and a reactor gas feed, wherein the reactor comprises a chemical vapor deposition reactor including a horizontal reactor tube configured to facilitate reaction of a catalyst due to flow of the gas feed through the reactor to form the carbon material and the reactor gas feed, and wherein the reactor gas feed is utilized to produce the syngas.
